(19) United States
(12) Patent Application Publication
(10) Pub. No.: US 2009/0219237 A1
(43) Pub. Date: Sep. 3, 2009

(54) ELECTRO-OPTICAL DEVICE, DRIVING METHOD THEREOF, AND ELECTRONIC APPARATUS

(75) Inventor: Katsunori YAMAZAKI, Matsumoto-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/267,127

(22) Filed: Nov. 7, 2008

(30) Foreign Application Priority Data
Feb. 29, 2008 (JP) 2008-049267

(51) Int. Cl. G09G 3/34

(52) U.S. Cl. 345/84

(57) ABSTRACT

In the hold-type display device that has a pixel connected to a storage capacitor via switching element, a frame period for driving the display device includes a first period, and a second period that is after the first period of the frame period. A voltage for black display is maintained from the beginning of the first period until a scanning line is selected. A voltage acquired by adding a predetermined voltage value to data signal is written to the pixel, when the scanning line is selected. In the second period, a voltage applied to at least one of the common electrode and the capacitor line connected to the storage capacitor is changed.

### BACKGROUND

1. Technical Field

The present invention relates to technology for suppressing blur of a moving image in a so-called hold-type display device.

2. Related Art

Electro-optical devices such as active matrix-type liquid crystal devices are hold-type devices in which a video is maintained over one frame period (16.7 milliseconds). Accordingly, when transition to the next frame is made, memory at a time when a video of the previous fame was visually recognized remains. Thus, when there is a movement of a video displayed in the consecutive frames, the movement area is visually perceived to be strange or blurred in the contour thereof (generation of a blur of a moving image).

On the other hand, in impulse-type display devices such as CRTs in which an image is displayed instantly, memory of an image displayed in the previous frame does not remain at a time when transition to the next frame is made, accordingly, the blur of a moving image is not generated. Thus, in the hold-type electro-optical devices, in order to imitate the display features of the impulse-type devices, technology in which a video is displayed by writing a voltage corresponding to the video in a dot sequential manner and thereafter a black image is displayed by writing a black-level voltage into the entire pixels by changing the voltages of capacitor lines has been proposed (see JP-A-2004-46235).

Here, in order to suppress the blur of a moving image more assuredly, a display period of the black image is needed to be lengthened. However, in the above-described technology, there is only one method in which the period of video display is shortened by increasing the writing speed for pixels and the remaining period is assigned to the display period of the black image for lengthening the display period of the black image. However, when the writing speed for the pixels is elevated, the configuration of the device becomes complex or the power consumption increases. Thus, there is a problem that the above-described technology cannot be employed to electronic devices in a field in which request for lowering the power consumption is strong.

### SUMMARY

An advantage of some aspects of the invention is that it provides an electro-optical device, a driving method thereof, and an electronic apparatus capable of suppressing the blur of moving images by lengthening the display period of the black image without increasing the writing speed for the pixels.

According to a first aspect of the invention, there is provided a method of driving an electro-optical device including: a plurality of scanning lines; a plurality of data lines; a plurality of pixels that are disposed in correspondence with intersections of the plurality of scanning lines and the plurality of data lines; a scanning line driving circuit that selects the plurality of scanning lines in a predetermined order in a first period of a first frame period; and a data line driving circuit that supplies data signals having voltage values corresponding to gray scales of pixels through the plurality of data lines to the pixels corresponding to the scanning line, for which a main selection operation is performed, among the plurality of scanning lines. Each of the plurality of pixels includes: a pixel switching element that has one end connected to the data line and is in the ON state between the one end and the other end at a time when the scanning line is selected; a pixel capacitor that has one end connected to the other end of the pixel switching element and the other end connected to a common electrode; and a storage capacitor that has one end connected to the other end of the pixel switching element and the other end connected to a capacitor line, The above-described method includes: maintaining a voltage for black display in the pixel capacitors corresponding to one of the plurality of scanning lines from when the first period is started to when the main selection operation is performed for the one scanning line; writing voltages acquired from adding a predetermined voltage value to voltages of the data signals into the pixel capacitors at a time when the main selection operation is performed for the one scanning line in the first period; and changing a voltage of at least one between the common electrode and the capacitor line in a second period that is a period after the first period of the first frame period.

According to the aspect above, the black latent image display is implemented in each pixel in the first period for selecting the plurality of scanning lines in a predetermined order, and real image display corresponding to the gray scale of each pixel is performed in the following second period. Accordingly, the display period of the black display can be lengthened without increasing the writing speed for the pixel. The meaning of the main selection operation will be described later.

In the above-described method, it may be configured that other scanning lines are additionally selected in a case where the main selection operation is performed for a first scanning line in the first period and the voltage value for the black display is maintained in the pixel capacitors corresponding to the other scanning lines. In such a case, when the main selection operation is performed for the first scanning line, the voltage value for the black display is simultaneously written into the pixel capacitors corresponding to the other scanning lines, and accordingly the number of selection operations for the scanning lines can be lowered, compared to a method in which all the plurality of scanning lines are selected at the start of the first period and then the main selection operation is performed for the plurality of scanning lines in a predetermined order.

In addition, in the above-described method, it may be configured that all the plurality of scanning lines are selected at the start of the first period, and then, the main selection operation is performed for the plurality of scanning lines in a predetermined order, and the voltage value for the black display is maintained for all the pixel capacitors at a time when all the plurality of scanning lines are selected. In such a case, it can be prevented that a capacitor load increases only in a case where the first scanning line is selected.

In the above-described method, it may be configured that the capacitor lines are divided into a group of the capacitor lines corresponding to the scanning lines of odd rows and a group of the capacitor lines corresponding to the scanning lines of even rows, when the main selection operation is performed for the scanning line of an odd row for the first time in the first period, the scanning lines of the other odd rows are additionally selected, and the voltage for the black display is maintained in the pixel capacitors corresponding to the scanning lines of the other odd rows, when the main selection operation is performed for the scanning line of an even row for the first time in the first period, the scanning lines of the other even rows are additionally selected, and the voltage for the black display is maintained in the pixel capacitors corresponding to the scanning lines of the other even rows, in the first period, when the main selection operation is performed for the scanning line of an odd row, the common electrode is set to have one between a low-level voltage or a high-level voltage, and when the main selection operation is performed for the scanning line of an even row, the common electrode is set to have the other between the low-level voltage and the high-level voltage, and when the main selection operation is performed for one of the plurality of the scanning lines, the data signal is set to have a voltage higher than the low-level voltage in a case where the common electrode is set to have the low-level voltage, and the data signal is set to have a voltage lower than the high-level voltage in a case where the common electrode is set to have the high-level voltage. In such a case, the writing polarity for the pixel is inverted in a scanning line inverting manner, and accordingly, generation of flicker or crosstalk is suppressed.

In the above-described method, it may be configured that the capacitor lines and the common electrodes are divided into a group corresponding to the scanning lines of odd rows and a group corresponding to the scanning lines of even rows, respectively, when the main selection operation is performed for the scanning line of an odd row for the first time in the first period, the scanning lines of the other odd rows are additionally selected, and the voltage for the black display is maintained in the pixel capacitors corresponding to the scanning lines of the other odd rows, when the main selection operation is performed for the scanning line of an even row for the first time in the first period, the scanning lines of the other even rows are additionally selected, and the voltage for the black display is maintained in the pixel capacitors corresponding to the scanning lines of the other even rows, in the first period, the common electrodes corresponding to the odd rows are set to have one between a low-level voltage and a high-level voltage, and the common electrodes corresponding to the even rows are set to have the other between the low-level voltage and the high-level voltage, the data signal at a time when the main selection operation is performed for the scanning line of the odd row is set to have a voltage higher than the low-level voltage in a case where the common electrodes of the odd row are set to have the low-level voltage, and the data signal at a time when the main selection operation is performed for the scanning line of the odd row is set to have a voltage lower than the high-level voltage in a case where the common electrodes of the odd row are set to have the high-level voltage, and the data signal at a time when the main selection operation is performed for the scanning line of the even row is set to have a voltage higher than the low-level voltage in a case where the common electrodes of the even row are set to have the low-level voltage, and the data signal at a time when the main selection operation is performed for the scanning line of the even row is set to have a voltage lower than the high-level voltage in a case where the common electrodes of the even row are set to have the high-level voltage. In such a case, the writing polarity for the pixel is inverted in the scanning line inverting manner. In addition, the number of times of voltage switching of the common electrode or the like decreases, and accordingly, it is possible to suppress the power consumption.

In the above-described method, it may be configured that the capacitor lines are associated with the plurality of scanning lines, the common electrode is maintained to have a predetermined reference electric potential, the voltage of the data signal is set to have one between a high-level voltage and a low-level voltage relative to the reference electric potential in a case where the main selection operation is performed for the scanning line of an odd row and is set to have the other between the high-level voltage and the low-level voltage in a case where the main selection operation is performed for the scanning line of an even row, when the main selection operation is performed for the scanning line of the odd row, in a case where the voltage of the data signal is set to have the high-level voltage, the capacitor line of the odd row for which the main selection operation is performed is set to have the low-level voltage and is switched to have the high-level voltage at a time when the main selection operation for the scanning line of the odd row is completed, when the main selection operation is performed for the scanning line of the odd row, in a case where the voltage of the data signal is set to have the low-level voltage, the capacitor line of the odd row for which the main selection operation is performed is set to have the high-level voltage and is switched to have the low-level voltage at a time when the main selection operation for the scanning line of the odd row is completed, when the main selection operation is performed for the scanning line of the even row, in a case where the voltage of the data signal is set to have the low-level voltage, the capacitor line of the even row for which the main selection operation is performed is set to have the high-level voltage and is switched to have the low-level voltage at a time when the main selection operation for the scanning line of the even row is completed, and when the main selection operation is performed for the scanning line of the even row, in a case where the voltage of the data signal is set to have the high-level voltage, the capacitor line of the even row for which the main selection operation is performed is set to have the low-level voltage and is switched to have the high-level voltage at a time when the main selection operation for the scanning line of the even row is completed. In such a case, the writing polarity for the pixel is inverted in the scanning line inverting manner. In addition, the voltage value of the common electrode is constant, and accordingly, it is possible to suppress the power consumption.

In addition, the invention may be conceived not only as a method of driving an electro-optical device, but also as an electro optical device. Furthermore, the invention may be conceived as an electronic apparatus having the electro optical device.

### BRIEF DESCRIPTION OF THE DRAWINGS

The invention will be described with reference to the accompanying drawings, wherein like numbers reference like elements.

FIG. 1 is a diagram showing the configuration of an electro-optical device according to a first embodiment of the invention.

FIG. 2 is a diagram showing the configuration of pixels of the electro-optical device.

FIG. 3 is a diagram showing the operation of the electro-optical device.

FIG. 4 is a diagram showing display using the electro-optical device.

FIG. 5 is a diagram showing a voltage-transmittance characteristic of the electro-optical device.

FIG. 6 is a diagram showing the operation according to an applied and modified example of the first embodiment.

FIG. 7 is a diagram showing the operation of an applied and modified example of the first embodiment.

FIG. 8 is a diagram showing display according to the applied and modified example.

FIG. 9 is a diagram showing the configuration of an electro-optical device according to a second embodiment of the invention.

FIG. 10 is a diagram showing the operation of the electro-optical device.

FIG. 11 is a diagram showing the configuration of an electro-optical device according to an applied and modified example of the second embodiment.

FIG. 12 is a diagram showing the operation of the electro-optical device according to an applied and modified example.

FIG. 13 is a diagram showing the configuration of an electro-optical device according to a third embodiment of the invention.

FIG. 14 is a diagram showing the operation of the electro-optical device.

FIG. 15 is a diagram showing an example of a capacitor line driving circuit of the electro-optical device.

FIG. 16 is a diagram showing signal waveforms of the electro-optical device.

FIG. 17 is a diagram showing a cellular phone using an electro-optical device according to an embodiment of the invention.

FIG. 18 is a diagram showing display by using an electro-optical device according to general technology.

### DESCRIPTION OF EXEMPLARY EMBODIMENTS

Hereinafter, embodiments of the present invention will be described with reference to the accompanying drawings.

### First Embodiment

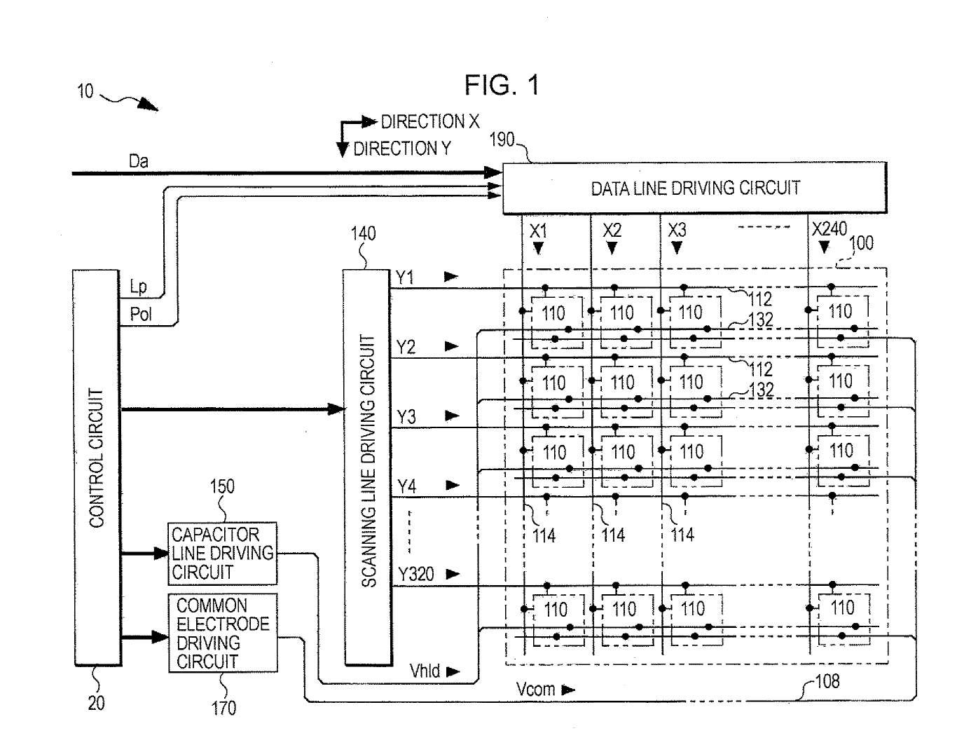

First, a first embodiment of the invention will be described. FIG. 1 is a block diagram showing the configuration of an electro-optical device according to the first embodiment.

As shown in the figure, in the electro optical device 10, a scanning line driving circuit 140, a capacitor line driving circuit 150, a common electrode driving circuit 170, and a data line driving circuit 190 are disposed near a display area 100. In addition, a control circuit 20 is configured to control the above-described constituent units of the electro optical device.

The display area 100 is an area in which pixels 110 are arranged. In this embodiment, scanning lines 112 of the 1st to 320th rows are arranged to extend in the direction of a row (X), and data lines 114 of the 1st to 240th columns are arranged to extend in the direction of a column (Y). In addition, in FIG. 1, the pixels 110 are arranged in correspondence with intersections between the scanning lines 112 of the 1st to 320th rows and the data lines 114 of the 1st to 240th columns. Accordingly, in this embodiment, the pixels 110 are arranged in the shape of a matrix having vertical 320 rows X horizontal 240 columns in the display area 100. However, the invention is not limited thereto.

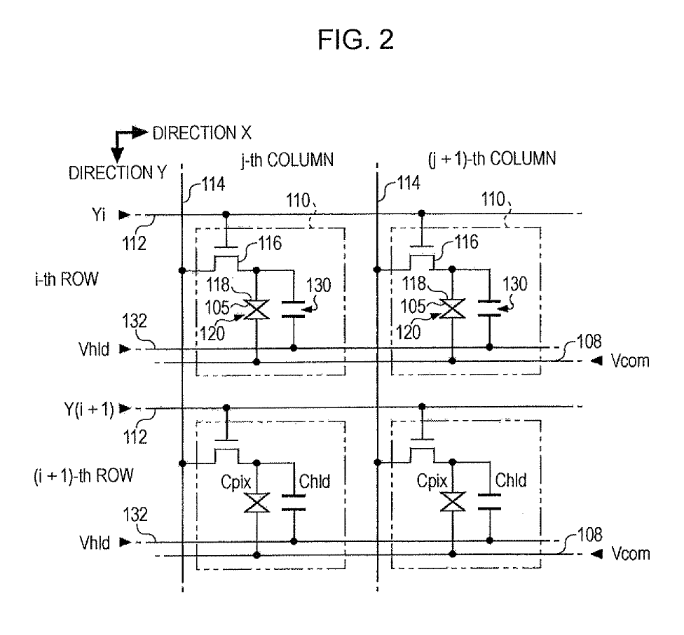

Here, a detailed configuration of the pixels 110 will be described. FIG. 2 is a diagram showing the configuration of the pixels 110. In the figure, the configuration of a total of four pixels of 2×2 corresponding to intersections of the i-th row and the (i+1)-th row adjacent thereto in the lower direction and the j-th column and the (j+1)-th column adjacent thereto on the right side is shown.

In addition, “i” and “(i+1)” are symbols for generally representing rows in which the pixels 110 are arranged, and are integers that are equal to or larger than “1” and are equal to or smaller than “320”. On the other hand, “j” and “(j+1)” are symbols generally representing columns in which the pixels 110 are arranged, and are integers that are equal to or larger than “1” and are equal to or smaller than “240”.

As shown in FIG. 2, each pixel 110 has an n-channel thin film transistor (hereinafter, abbreviated as a TFT) 116 that serves as a pixel switching element, a pixel capacitor (liquid crystal capacitor) 120, and a storage capacitor 130. Since the pixels 110 have a same configuration, a pixel located in the i-th row and the j-th column will be described here representatively. The TFT 116 of the pixel 110 of the i-th row and the j-th column has a gate electrode that is connected to the scanning line 112 of the i-th row, a source electrode that is connected to the data line 114 of the j-th column, and a drain electrode that is connected to a pixel electrode 118, which is one end of the pixel capacitor 120, and one end of the storage capacitor 130.

In addition, the other end of the pixel capacitor 120 is connected to a common electrode 108, and the other end of the storage capacitor 130 is connected to a capacitor line 132.

In this embodiment, the common electrode 108 is common to the pixels 110. To the common electrode 108, a common signal Vcom is supplied from the common electrode driving circuit 170. In addition, in this embodiment, the capacitor line 132 is common to the pixels 110. To the capacitor line 132, a capacitor signal Vhld is supplied from the capacitor line driving circuit 150.

The voltage waveforms of the common signal Vcom and the capacitor signal Vhld will be described later. In addition, in FIG. 2, Yi and Y(i+1) denote scanning signals supplied to the i-th and (i+1)-th scanning lines 112, and Cpix and Chld denote capacitance of the pixel capacitor 120 and the capacitance of the storage capacitor 130.

The display area 100 is configured by bonding one pair of substrates including a component substrate on which the pixel electrode 118 is formed and an opposing substrate on which the common electrode 108 is formed with a predetermined gap maintained therebetween so as to place electrode forming faces thereof face each other. In addition, in the gap, a liquid crystal is 105 sealed.

In this embodiment, the liquid crystal 105 is operated in the OCB (Optical Compensated Birefringence) mode. Thus, in the initial state, liquid crystal molecules are in a spray alignment in which the crystal molecules are open between two substrates in a spray shape. On the other hand, in a display operation, the liquid crystal molecules are in a state in which the liquid crystal molecules are bent (bend alignment) like a bow, and the transmittance of the liquid crystal changes in accordance with the degree of bending in the bend alignment. Thus, as shown in FIG. 5, a normally white mode is used in this embodiment. In the normally white mode, the transmittance of light becomes the maximum to display white in a case where the root mean square value of a voltage maintained in the pixel capacitor 120 is Vwt that is close to zero, the intensity of transmitted light decreases as the root mean square value of the voltage increases, and the transmittance almost saturates to display black in a case where the root mean square value of the voltage is equal to or larger than Vblk.

As is well known, in the OCB mode, when the root mean square value of the voltage maintained in the pixel capacitor 120 is below a threshold voltage Vcrt, the liquid crystal molecules are returned to the spray alignment, and thus, as shown by a broken line in the figure, the transmittance cannot be controlled in accordance with the root mean square value. Accordingly, the liquid crystal molecules are needed to be transited to the bend alignment by applying a voltage that is equal to or higher than the threshold voltage Vcrt before the liquid crystal is controlled to have target transmittance.

Referring back to FIG. 1, the control circuit 20 outputs various control signals for controlling units of the scanning line driving circuit 140, the capacitor line driving circuit 150, the common electrode driving circuit 170, and the data line driving circuit 190. The content of the control operation will be covered later in descriptions of each unit.

The scanning line driving circuit 140 supplies scanning signals Y1, Y2, Y3, Y4, . . . , Y319, Y320 to the scanning lines 112 of the 1st, 2nd, 3rd, 4th, . . . , 319th, 320th rows in a period Hb of one frame in accordance with control of the control circuit 20.

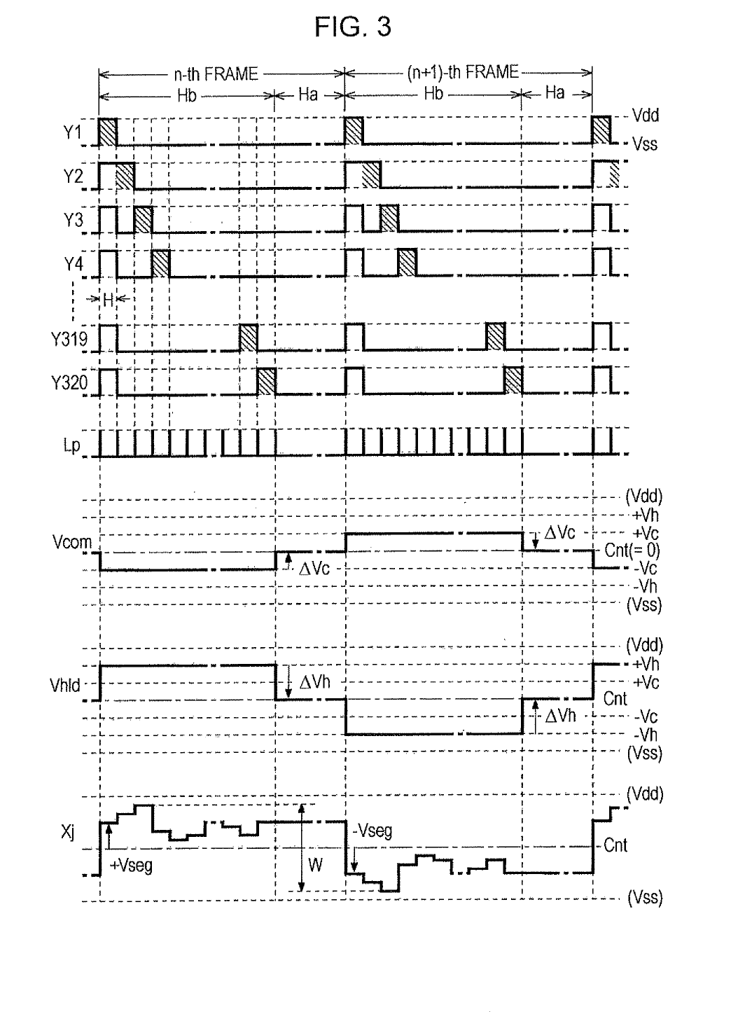

In particular, in this embodiment, the scanning line driving circuit 140, as shown in FIG. 3, basically selects the scanning lines 112 in order of the 1st, 2nd, 3rd, 4th, . . . , 319th, 320th rows, counted from the top in FIG. 1, in the period Hb, sets the scanning signals for the selected scanning lines to level H, and sets the scanning signals for other scanning lines to level L. However, as an exception, when the first scanning line 112 is selected, the scanning line driving circuit 140 simultaneously selects the other scanning lines 112 of the 2nd to 320th rows.

Accordingly, according to this embodiment, the scanning signals Y1 to Y320 altogether become level H at the start of one frame period Hb, and then, only the scanning signals Y2, Y3, . . . , Y319, Y320 become level H one after another. The scanning lines of the 2nd to 320th rows are selected twice in the period Hb, and there is a case where the latter selection operation (a selection operation for writing a voltage acquired from adding absolute values of the voltage corresponding to a gray scale and the voltage of the common electrode into the pixel capacitor) is referred to as a main selection operation so as to differentiate the selection operations from each other. In FIG. 3, periods in which the main selection operations are performed for the 2nd to 320th rows are hatched. In addition, according to this embodiment, the 1st row is selected only once in the period Hb, and thus, the selection operation becomes the main selection operation.

In addition, a period in which the scanning signal for a scanning line becomes level L is a non-selection period of the scanning line. The level H of the scanning signal is set as selection electric potential Vdd, and the level L of the scanning signal is set as non-selection electric potential Vss. In this embodiment, during one frame period, a period that is a remaining period other than the period Hb and the latter period is set as Ha.

However, the pixel capacitor 120 is needed to be AC driven so as to prevent deterioration of the liquid crystal 105. In AC driving the pixel capacitor 120, there are various examples such as row inversion, pixel inversion, scanning line inversion, and the like for determining the writing polarity. In this embodiment, a frame inversion mode in which a same polarity is used for all the pixel capacitors 120 in one frame and the writing polarities are inverted for each one frame is used.

A polarity designating signal Pol is a signal for designating the writing polarity of the pixel capacitor 120. However, in the frame inversion mode, the writing polarity is inverted for each one frame, and thus, the polarity designating signal is not need to be drawn particularly. In FIG. 3, a frame for which positive polarity writing is designated is denoted by “n-th frame”, and a frame for which negative polarity writing is designated is denoted by “(n+1)-th framer”.

In addition, according to this embodiment, when a voltage is maintained in the pixel capacitor 120, a case where the pixel electrode 118 is set as a high electric potential side with respect to the electric potential of the common electrode 108 is configured to be the positive polarity as the writing polarity. On the other hand, a case where the pixel electrode 118 is set as a low electric potential side with respect to the electric potential of the common electrode 108 is configured to be the negative polarity as the writing polarity. Thus, unless otherwise described, the center electric potential Cnt between the selection electric potential Vdd and the non-selection electric potential Vss is used as a reference for zero voltage. The reason is that the electric potential of the common signal Vcom becomes the center electric potential Cnt in this embodiment, as described later, when a voltage value for transmittance corresponding to the gray scale is maintained in the pixel electrode 120.

The common electrode driving circuit 170 outputs a common signal Vcom having a voltage value as below under the control of the control circuit 20. In particular, as shown in FIG. 3, the common electrode driving circuit 170 sets the common signal Vcom to a voltage value of −Vc over the period Hb in the n-th frame for which the positive polarity writing is designated and sets the common voltage Vcom to a voltage value of +Vc over the period Hb in the n-th frame for which the negative polarity writing is designated. In addition, the common electrode driving circuit 170 sets the common signal Vcom to zero voltage (the electric potential Cnt) in the period Ha of each frame.

Next, the capacitor line driving circuit 150 outputs the capacitor signal Vhld having a voltage value described below under the control of the control circuit 20. In particular, as shown in the figure, the capacitor line driving circuit 150 sets the capacitor signal Vhld to a voltage value of +Vh over the period Hb in the n-th frame and sets the capacitor signal Vhld to a voltage value of −Vh over the period Hb in the (n+1)-th frame. In addition, the capacitor line driving circuit 150 sets the capacitor signal Vhld to zero voltage (the electric potential Cnt) in the period Ha of each frame.

In addition, a latch pulse Lp is output at a timing when the scanning line is selected and the scanning signal becomes the level H.

The data line driving circuit 190 supplies a data signal of a voltage value corresponding to the gray scale and the polarity designated in accordance with the polarity designating signal Pol to the pixels 110 located in the scanning line that is selected by the main selection operation of the scanning line driving circuit 140 through the data lines 114. In particular, since this embodiment employs the normally white mode, the data line driving circuit 190 sets the voltage value of the data signal to be higher than the electric potential Cnt as the designated gray scale is darkened in a case where the positive polarity writing is designated. On the other hand, in a case where the negative polarity writing is designated, the voltage of the data signal is set to be lower than the electric potential Cnt as the designated gray scale is darkened.

The data line driving circuit 190 has memory areas (not shown) corresponding to the matrix arrangement of vertical 320 rows×horizontal 240 columns. In each memory area, display data Da that designates the gray scale (brightness) of a corresponding pixel 110 is stored.

In addition, when there is a change of the display content, the display data Da stored in each memory area can be overwritten as the display data Da after the change is supplied.

The data line driving circuit 190 performs an operation of reading the display data Da of the pixels 110 of one row, which are located in the selected scanning liner from the memory areas, converting the display data into a data signal having a voltage value corresponding to the gray scale designated in accordance with the read display data and the designated polarity, and supplying the data signal to the data line 114 for each one of the 1st to 240th rows that area located in the selected scanning line.

In addition, the data line driving circuit 190 can acquire that the scanning signal of which row becomes the level H by counting the latch pulse Lp from the start of one frame period and can acquire a timing for start of selecting the scanning line based on the timing for supply of the latch pulse Lp.

Next, the operation of the electro-optical device 10 according to this embodiment will be described with reference to FIG. 3.

At the start of the period Hb of the n-th frame for which the positive writing is designated, the main selection operation is performed for the 1st row, and thus the scanning signal Y1 becomes the level H.

When the scanning signal Y1 becomes the level H, the data line driving circuit 190 supplies positive polarity voltages corresponding to the gray scales of the 1st row and 1st column to the 1st row and 240th column to the data lines 114 of the 1st to 240th columns as data signals X1 to X240. Since the scanning signal Y1 is the level H, the TFTs 116 of the pixels 110 of the 1st row are turned on. Accordingly, to the pixel electrodes 118 that are one ends of the pixel capacitors 120 of the 1st row and 1st column to the 1st row and 240th column, positive polarity voltages corresponding to the gray scales are applied.

However, the common signal Vcom supplied to the common electrode 108 in the period Hb of the n-th frame has the voltage value of −Vc. Accordingly, for example, when the voltage value of the data signal Xj supplied to the data line 114 of the j-th column is denoted by +Vseg, the pixel capacitor 120 of the 1st row and j-th column is charged to have a voltage value of +(Vseg+Vc) that is acquired from subtracting the voltage value −Vc of the common signal Vcom from the voltage value +Vseg of the data signal Xj.

Here, the absolute value of the voltage value +(Vseg+Vc) is set so as to satisfy the condition that the absolute value is equal to or larger than the voltage Vblk, for which the pixel capacitor 120 operated in the normally white mode becomes black, and is equal to or larger than a threshold voltage Vcrt of the liquid crystal 105 operated in the OCB mode. In addition, actually, the voltage Vseg is determined in accordance with the gray scale of the pixel, the voltage −Vc of the common signal Vcom can be determined such that the absolute value of the voltage value +(Vseg+Vc) becomes equal to or larger than the voltage Vblk and is equal to or larger than the threshold voltage Vcrt regardless of the voltage Vseg.

As described above, in the period Hb of the n-th frame, when the scanning signal Y1 becomes the level H, voltages having the positive polarity corresponding to the gray scales are applied to the pixel electrodes 118 of the 1st row and 1st column to the 1st row and 240th column. However, the common electrode 108 has the voltage −Vc, and thus voltages acquired from adding the absolute values of the voltages corresponding to the gray scales and the voltage of the common electrode 108 is charged to the pixel electrodes 120. As a result, the pixels 110 of the 1st row become black display (black latent image display).

In addition, when the scanning signal Y1 is the level H, other scanning signals Y2 to Y320 simultaneously become the level H, and accordingly, the TFTs 116 of the pixels 110 of the 2nd to 320th rows are turned on. Accordingly, when the j-th row is considered, the voltage (Vseg+Vc) is charged similarly to the pixel capacitors 120 of the 2nd row and j-th column to the 320th row and j-th column. As a result, the black latent image display is implemented in the pixels 110 of the 2nd to 320th rows. At this moment, the voltages charged to the pixel capacitors 120 of the 2nd to 320th rows depend on the gray scales of the 1st row, regardless of the gray scales of the 2nd row.

Next, in the period Hb of the n-th frame, the main selection operation is performed for the 2nd row. Thus, only the scanning signal Y2 becomes the level H, and other scanning signals become the level L.

When the scanning signal Y2 becomes the level H, the data line driving circuit 190 supplies positive polarity voltages corresponding to the gray scales of the 2nd row and 1st column to the 2nd row and 240th column to the data lines 114 of the 1st to 240th columns as data signals X1 to X240. Since the scanning signal Y2 is the level H, the TFTS 116 of the pixels 110 of the 2nd row are turned on. Accordingly, to the pixel electrodes 118 of the 2nd row and 1st column to the 2nd row and 240th column, the data signals X1 to X240 having positive polarity voltages corresponding to the gray scales are applied.

However, the common electrode 108 has the voltage −Vc, and accordingly, the pixel capacitors 120 of the 2nd row are charged to voltage values acquired from subtracting the voltage −Vc from the positive polarity voltages corresponding to the gray scales again. As a result, the black latent image display is continuously maintained in the pixels 110 of the 2nd row.

In addition, for the 1st row and the 3rd to 320th rows, the TFTs 116 are turned off. However, the voltages charged to the pixel capacitors do not change, and accordingly, the black latent image display represented at a time when the scanning signals Y1 to Y320 become the level H is maintained.

Subsequently, only the scanning signal Y3 becomes the level H, and the TFTs 116 of the pixels 110 of the 3rd rows are tuned on. In addition, the data line driving circuit 190 supplies positive polarity voltages corresponding to the gray scales of the 3rd row and 1st column to the 3rd row and 240th column to the data lines 114 of the 1st to 240th columns as the data signals X1 to X240. Accordingly, to the pixel electrodes 118 of the 3rd row and 1st column to the 3rd row and 240th column, the data signals X1 to X240 having positive polarity voltages corresponding to the gray scales are applied. However, the common electrode 108 has the voltage −Vc, and accordingly, the pixel capacitors 120 of the 3rd row are charged to voltage values acquired from subtracting the voltage −Vc from the positive polarity voltages corresponding to the gray scales again. As a result, the black latent image display is continuously maintained in the pixels 110 of the 3rd row.

In addition, for the 2nd row, the TFTs 116 are turned off. However, the voltages charged to the pixel capacitors do not change, and accordingly, the black latent image display represented at a time when only the scanning signal Y2 becomes the level H is maintained.

In the period Hb of the n-th frame, the above-described operations are repeated, and the pixel capacitors 120 of up to the 320th row are charged to voltage values acquired from subtracting the voltage −Vc from the positive polarity voltages corresponding to the gray scales again. Accordingly, the black latent image display is maintained in all the pixels for the period Hb.

Next, in the period Ha of the n-th frame, the common signal Vcom supplied to the common electrode 108 increases from the voltage −Vc to the zero voltage by a voltage ΔVc, and the capacitor signal Vhld supplied to the capacitor line 132 decreases from the voltage +Vh to zero voltage by a voltage ΔVh.

Here, for example, the voltage +(Vseg+Vc) charged in the pixel capacitor 120 of the 1st row and j-th column for the period Hb changes to (Vseg+Vc)−Chld(ΔVc+ΔVh)/(Cpix+Chld) for the period Ha.

In other words, the voltage of the pixel capacitor 120 that is charged to the voltage +(Vseg+Vc) during the period Hb decreases by a voltage Chld(ΔVc+ΔVh)/(Cpix+Chld) during the period Ha. The reason for this is that the voltages of the common electrode 108 and the capacitor line 132 that are both ends of a serial connection of the pixel capacitor 120 and the storage capacitor 130 change in a state that the TFT 116 is turned off and charges accumulated in the pixel capacitor 120 and the storage capacitor 130 are redistributed.

For this voltage change, when the voltage ΔVc and the voltage ΔVh are set such that the absolute value of the voltage −Vc of the common electrode for the period Hb becomes a voltage decrease of Chld(ΔVc+ΔVh)/(Cpix+Chld), the voltage maintained in the pixel capacitor 120 for the period Ha becomes Vseg. Accordingly, when the voltages ΔVc and ΔVh are set as described above, the transmittance of the pixel 110 of the 1st row and j-th column can be set in accordance with the gray scale for the period Ha. Here, although a description is made for the pixel of the 1st row and j-th column, all the other pixels altogether have transmittance corresponding to the gray scales in the period Ha of the n-th frame. Accordingly, a desired image can be displayed (real image display).

Next, the operation for (n+1)th frame for which negative polarity writing is designated will be described.

First, at the start of the period Hb of the (n+1)-th frame, the main selection operation is performed for the 1st row, and thus the scanning signal Y1 becomes the level H. When the scanning signal Y1 becomes the level H, the data line driving circuit 190 supplies negative polarity voltages corresponding to the gray scales of the 1st row and 1st column to the 1st row and 240th column to the data lines 114 of the 1st to 240th columns as the data signals X1 to X240. Accordingly, to the pixel electrodes 118 of the 1st row and 1st column to the 1st row and 240th column, negative polarity voltages corresponding to the gray scales are applied.

However, for example, when the voltage value of the data signal Xj supplied to the data line 114 of the j-th column is denoted by Vseg, the common electrode 108 has the voltage +Vc in the period Hb of the n-th frame. Accordingly, the pixel capacitor 120 of the 1st row and j-th column is charged to have a voltage value of −(Vseg+Vc) that is acquired from subtracting the voltage value +Vc of the common electrode 108 from the voltage value −Vseg of the data signal Xj. As a result, the black latent image display is implemented in the pixel of the 1st row and j-th row. In addition, the black latent image display is implemented in other pixels of the 1st row.

In addition, when the scanning signal Y1 is the level H, the scanning signals Y2 to Y320 become the level H, and accordingly, the black latent image display, which is the same for the pixel of the 1st row, is implemented in the pixels of the 2nd to 320th rows.

Next, in the period Hb of the (n+1)-th frame, only the scanning signal Y2 becomes the level H.

When the scanning signal Y2 becomes the level H, the data line driving circuit 190 outputs negative polarity voltages corresponding to the gray scales of the 2nd row and 1st column to the 2nd row and 240th column as the data signals X1 to X240. However, the common electrode 108 has the voltage +Vc, and accordingly, the pixel capacitors 120 of the 2nd row are charged to voltage values acquired from subtracting the voltage +Vc from the negative polarity voltages corresponding to the gray scales again. As a result, the black latent image display is continuously maintained in the pixels 110 of the 2nd row.

In addition, for the 1st row and the 3rd to 320th rows, the voltages charged to the pixel capacitors 120 do not change, and accordingly, the black latent image display represented at a time when the scanning signals Y1 to Y320 become the level H is maintained.

In the period Hb of the (n+1)-th frame, the scanning signals Y3, Y4, Y5, . . . , Y320 become the level H one after another. Accordingly, the pixel capacitors 120 of the 3rd, 4th, 5th, . . . , 320th rows are charged to have voltage values that are excessive by the voltage Vc with respect to the voltages corresponding to the gray scales again. Accordingly, the black latent image display is maintained in all the pixels for the period Hb.

Subsequently, in the period Ha of the (n+1)-th frame, the voltage value of the common electrode 108 decreases from the voltage +Vc to the zero voltage by a voltage ΔVc, and the voltage of the capacitor line 132 increases from the voltage −Vh to zero voltage by a voltage ΔVh.

Here, for example, the voltage −(Vseg+Vc) charged in the pixel capacitor 120 of the 1st row and j-th column for the period Hb decreases by a voltage Chld(ΔVc+ΔVh)/(Cpix+Chld) as the absolute value due to redistribution of charges during the period Ha.

For this voltage change, the voltage ΔVc and the voltage ΔVh are set such that the absolute value of the voltage +Vc of the common electrode for the period Hb becomes a voltage decrease of Chld(ΔVc+ΔVh)/(Cpix+Chld). Accordingly, the voltage maintained in the pixel capacitor 120 for the period Ha becomes −Vseg with the electric potential of the common electrode used as a reference. Accordingly, the transmittance of the pixel 110 of the 1st row and j-th column can be set in accordance with the gray scale for the period Ha in the (n+1)-th frame. Here, although a description is made for the pixel of the 1st row and j-th column, all the other pixels altogether have transmittance corresponding to the gray scales in the period Ha, and accordingly, an image desired to be displayed can be displayed (real image display).

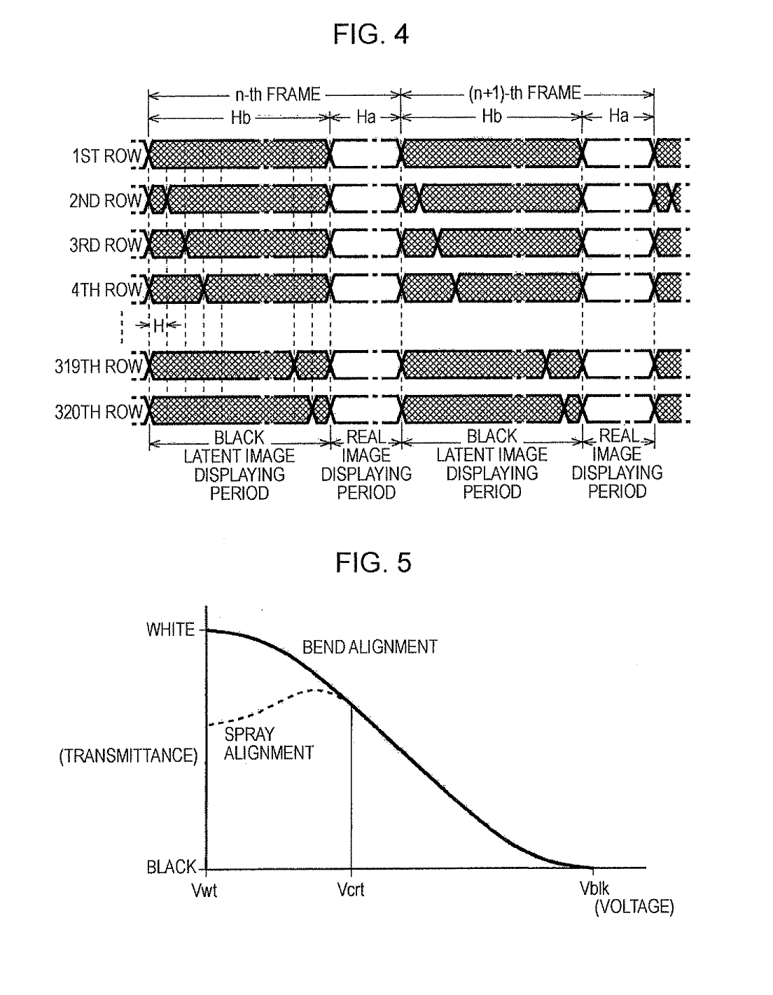

In a simple hold type, an image remains in a same position for a frame period, and thus, when a moving image is displayed, a blur is generated in the contour thereof. Accordingly, in the hold type, so-called a black inserting display method in which a black display period is inserted in a period for video display for each frame has been proposed, as is described above in “Related Art”. According to this embodiment, as shown in FIG. 4, the black latent image display is implemented in all the pixels 110 for the period Hb of each frame, and the real image display, in which the transmittance of all the pixels is set in accordance with the gray scales all together, is implemented in all the pixels for the period Ha. As a result, according to this embodiment, since a black image is inserted during a real image displaying operation, the blur of the moving image is suppressed.

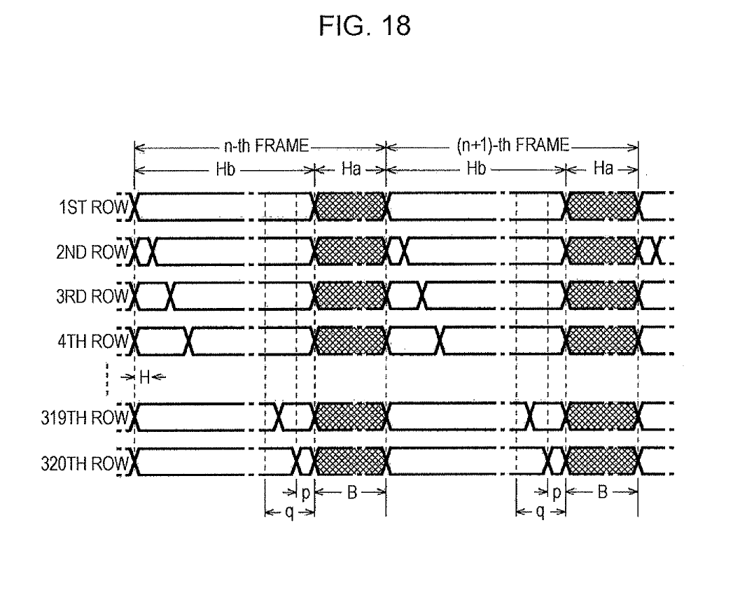

Here, in order to lengthen a black display period Hd in a general configuration as shown in FIG. 18 in which voltages corresponding to a video are line-sequentially written in the pixels for a period Hc as an image display period and black-level voltages are written into all the pixels for the period Hd after completion of the writing process as a black display period, the video display period Hc should be shortened by speeding up the writing operation for the pixels and the shortened period should be assigned to the display period of the black image.

When an amorphous transistor is used as a constituent element of the scanning line driving circuit 140 or the data line driving circuit 190, if the writing speed for the pixel increases, there are various problems such as uneven display caused by an insufficient writing process at low temperature, or an increase of the size of the transistor and an increase of a voltage level of a power supply for avoiding the uneven display.

On the other hand, according to this embodiment, as shown in FIG. 4, black latent image display is implemented in the period Hb that is used for writing data signals into the pixel electrodes 118 of each row, then the voltages of the common electrode 108 and the capacitor line 132 are changed, and the voltages maintained in the pixel capacitors 120 are changed all together to values corresponding to the gray scales for displaying a real image Thus, the display period for the black image can be lengthened without increasing the writing speed for the pixels. Accordingly, in this embodiment, it is possible to suppress the blur of the moving images more assuredly.

In addition, as described above, in a case where a gray scale is represented by using the bend alignment of the OCB liquid crystal or the like, when the voltage applied to the pixel capacitor 120 is below the threshold voltage Vcrt as shown in FIG. 5, the alignment of the liquid crystal is transited from the bend alignment to the spray alignment. When a voltage equal to or higher than the threshold voltage Vcrt is applied to the pixel capacitor 120 in a display process for preventing the transition, high transmittance cannot be implemented.

However, when a voltage below the threshold voltage Vcrt is applied to the pixel capacitor 120 for a short time period after a voltage equal to or higher than the threshold voltage Vcrt is continuously applied to the pixel capacitor 120, the bend alignment is maintained.

Here, in this embodiment, a voltage for the black latent image display, that is, a voltage equal to or higher than the threshold voltage Vcrt is applied in the period Hb regardless of display. Thus, even when a voltage below the threshold voltage Vcrt is applied in the period Ha thereafter, the bend alignment is maintained for the period Ha that is relatively short. Accordingly, in this embodiment, bright white display in which the bend alignment is maintained can be implemented for the period Ha.

In addition, in this embodiment, both the voltage of the common electrode 108 and the voltage of the capacitor line 132 do not change in the period Ha. However, the voltages of ΔVc and ΔVh can be set such that the absolute value of the voltage ±Vc of the common electrode applied in the period Hb is the same as the voltage decrease of Chld(ΔVc+ΔVh)/(Cpix+Chld). Accordingly, one between the voltages of ΔVc and ΔVh can be set to zero. In other words, the voltage of one between the common electrode 108 and the capacitor line 132 can be configured not to be changed from the period Hb to the period Ha.

### Applied and Modified Example of First Embodiment

In the above-described first embodiment, the reference of the writing polarity is set to the electric potential Cnt for the simplification of descriptions. However, when the reference of the writing polarity is set to the electric potential Cnt, the voltage amplitudes W of the data signals X1 to X240 increase, and the withstand voltage of the data line driving circuit 190 is required to be relatively high.

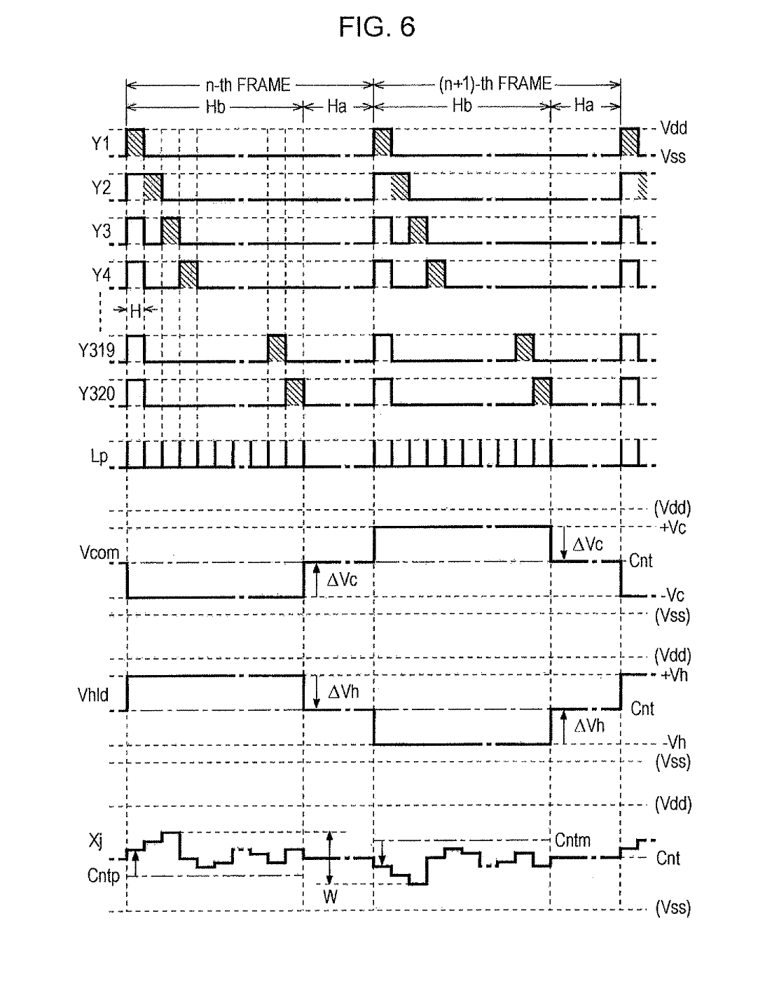

From the point of view of the invention, a voltage that is excessively higher than the voltage corresponding to the gray scale is written into the pixel capacitor 120 in the period Hb for implementing the black latent image display, and the real image display is implemented by using a voltage corresponding to the gray scale by changing the voltage of at least one between the common electrode 108 and the capacitor line 132 in the period Ha. Thus, as shown in FIG. 6, in the period Hb of the n-th frame for which the positive polarity writing is designated, the reference electric potential of the writing polarity is set to be lowered to be the electric potential Cntp and the voltage Vc of the common electrode 108 is set to be lowered. In addition, in the period Hb of the (n+1)-th frame for which the negative polarity is designated, reversely, the reference electric potential of the wiring potential is set to be elevated to be the electric potential Cntm, and the voltage +Vc of the common electrode 108 is set to be elevated. As a result, the voltage amplitude W of the data signals X1 to X240 can decrease. In particular, in the normally white mode, when the black (white) voltage having the positive polarity and the white (black) voltage having the negative voltage are the same, the voltage amplitude can decrease by a half.

In addition, since the voltage change ΔVh is important for the capacitor line 132, the voltage of the capacitor line 132 for the periods Ha and Hb may have any arbitrary value as long as the voltage change of ΔVh is acquired.

In addition, according to the above-described first embodiment, the scanning signals Y1 to Y320 are set to the level H all together at the start of the period Hb, voltages acquired from adding the absolute values of the voltage of the common electrode to voltages corresponding to the gray scales are written into the pixel capacitors 120 of the 1st row, and added voltages of same columns are written into the pixels of the 2nd to 320th rows altogether. Accordingly, the first embodiment is configured to implement the black latent image display at the start of the period Ha. However, under this configuration, a load for writing the voltages into the pixel capacitors 120 of the 1st row for which the main selection operation is performed is higher than that for writing the voltages into the pixel electrodes of the 2nd to 320th rows, and thereby there is a possibility that uneven display is generated.

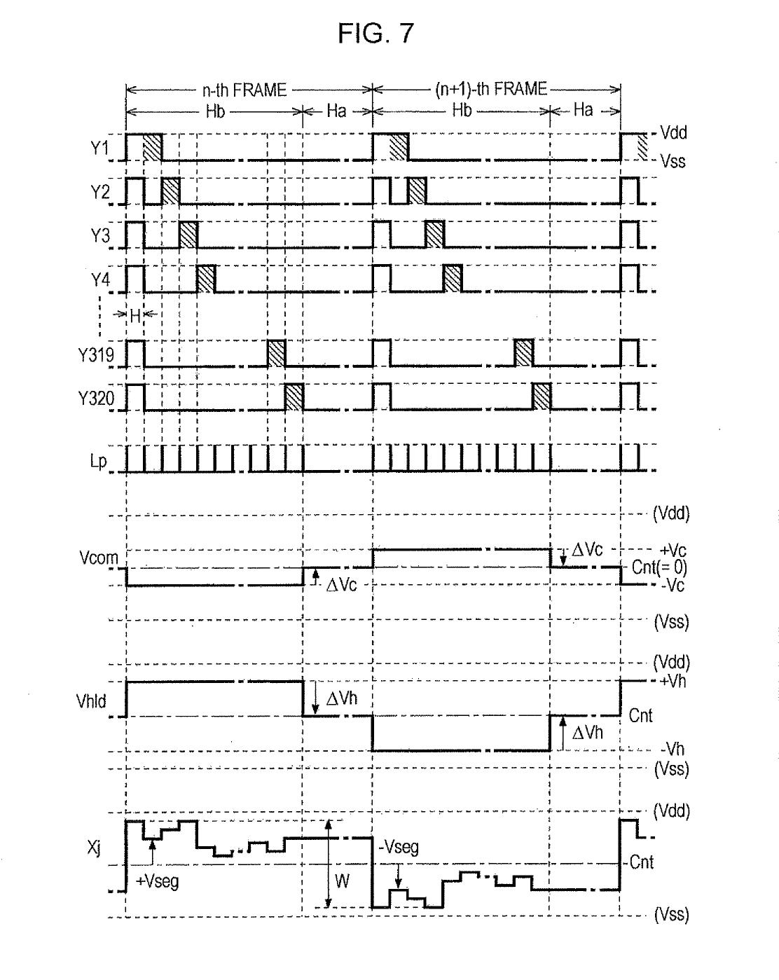

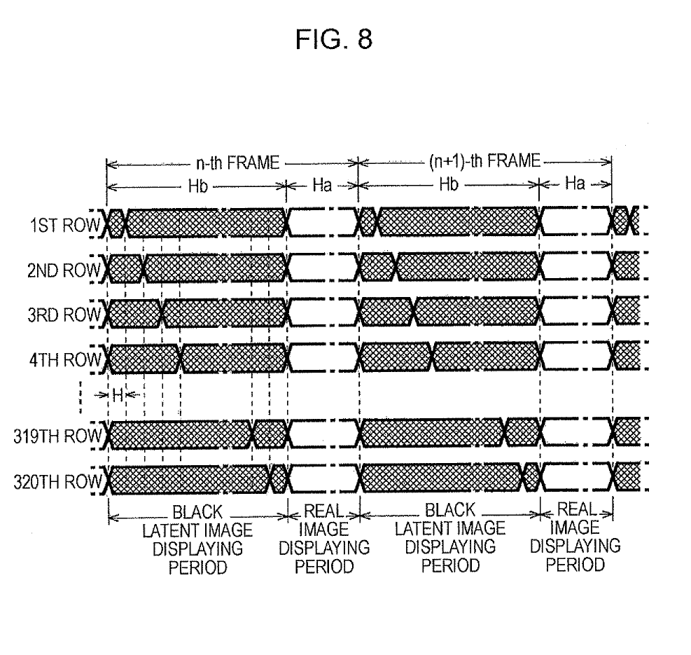

Thus, as shown in FIGS. 7 and 8, a configuration in which the scanning signals Y1 to Y320 are set to the level H all together so as to forcedly write voltages for the black latent image display into all the pixels before the main selection operation for the 1st row is performed and voltages acquired from adding the voltage of the common electrode to the voltages corresponding to the gray scales are written by performing the main selection operation for the pixels of the 1st, 2nd, 3rd, 4th, . . . , 319th, 320th rows may be used.

Under this configuration, loads for writing the voltages acquired from adding the voltage of the common electrode to the voltages corresponding to the gray scales become equivalent for each row, and accordingly, it is possible to suppress generation of uneven display

### Second Embodiment

In the above-described first embodiment, a frame inversion method in which all the pixel capacitors 120 are set to have a same polarity for one frame and the writing polarity is inverted for each one frame is used. However, when the frame inversion method is used, there is a high possibility that flicker or crosstalk is visually recognized. Thus, a second embodiment of the invention in which the scanning line inversion method is used will now be described.

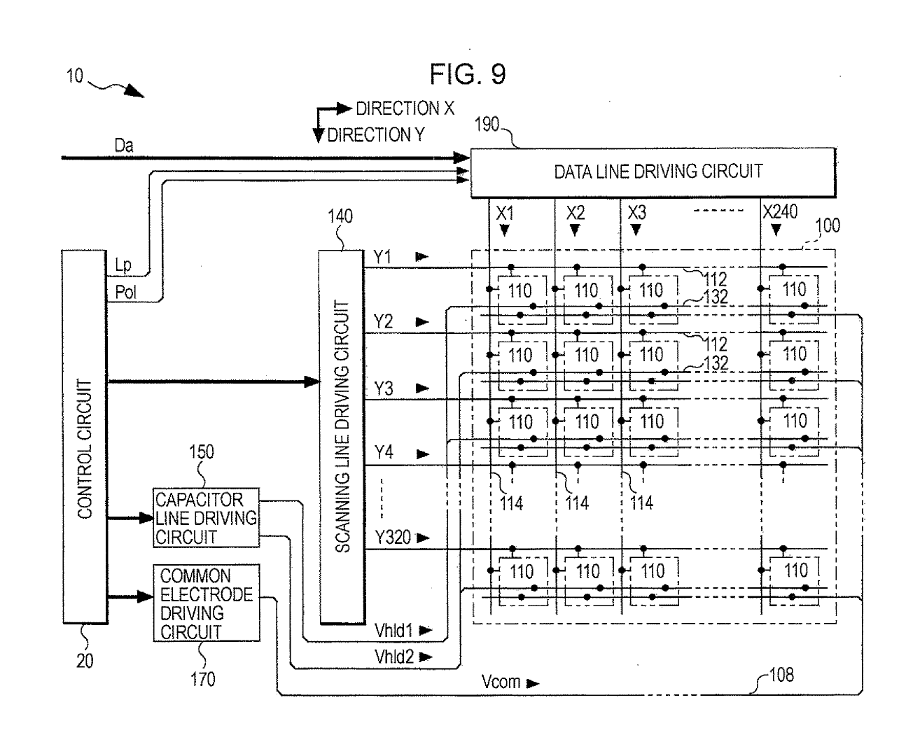

FIG. 9 is a block diagram showing the configuration of an electro-optical device according to the second embodiment. As shown in the figure, according to the second embodiment, a configuration in which the capacitor lines 132 are divided into a group of capacitor lines of odd (1, 3, 5, 319) rows and a group of capacitor lines of even (2, 4, 6, . . . , 320) rows, and the capacitor line driving circuit 150 supplies a capacitor signal Vhld1 to the capacitor lines 132 of the odd rows and supplies a capacitor signal Vhld2 to the capacitor lines 132 of the even rows is used.

Here, since the scanning line inversion method is used in the second embodiment, for the n-th frame, the positive polarity writing is designated for the capacitor lines of the odd rows and the negative polarity writing is designated for the capacitor lines of the even rows. In addition, for the (n+1)-th frame, on the contrary, the negative polarity writing is designated for the capacitor lines of the odd rows and the positive polarity writing is designated for the capacitor lines of the even rows.

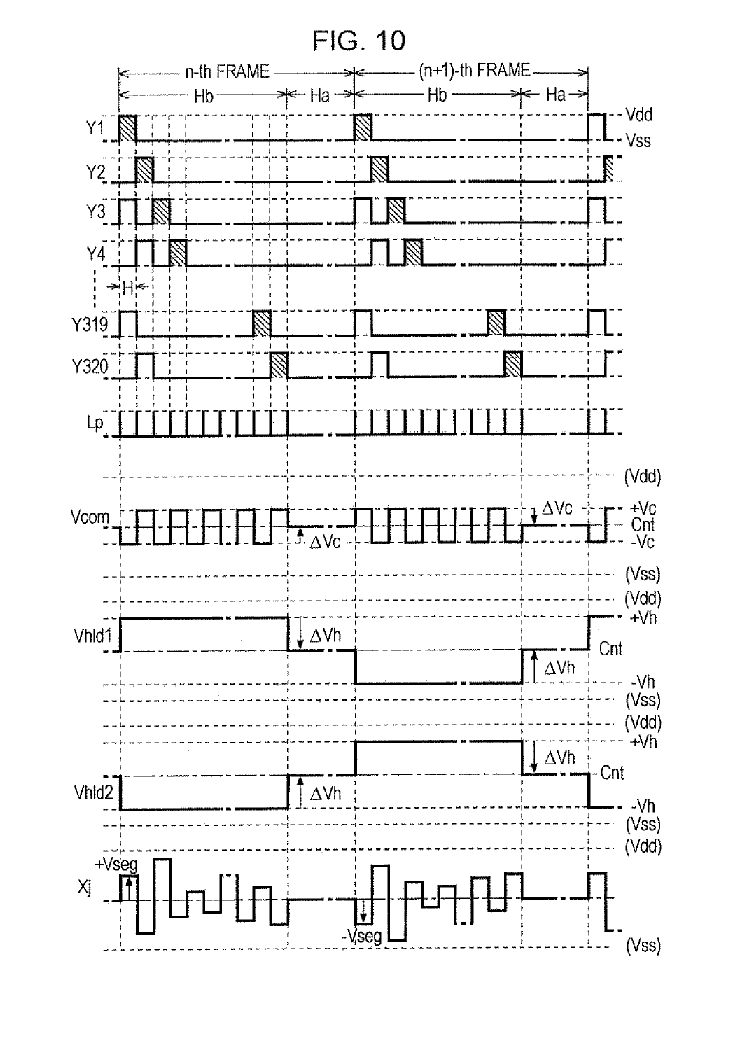

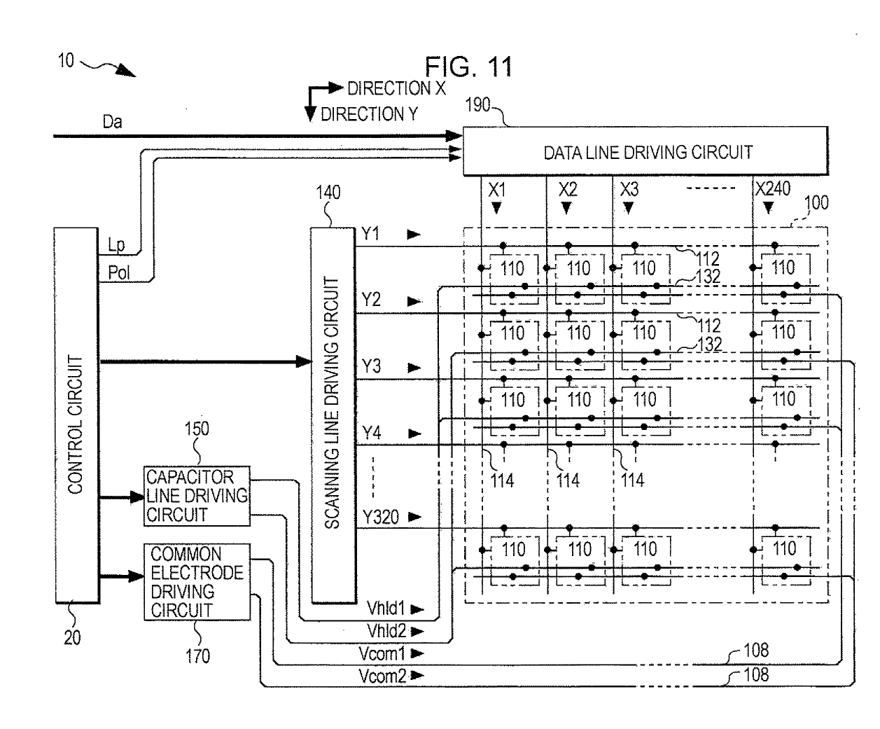

In the above-described scanning line inversion, the common electrode driving circuit 170 supplies the common signal Vcom having a voltage as described below to the common electrode 108. In other words, as shown in FIG. 10, the common electrode driving circuit 170, for the period Hb of the n-th frame, sets the voltage of the common signal Vcom to the voltage −Vc at a time when the main selection operation is performed for the odd rows and sets the voltage of the common signal to the voltage +Vc at a time when the main selection operation for the even rows is performed. In addition, the common electrode driving circuit 170, for the period Hb of the (n+1)-th frame, sets the voltage of the common signal Vcom to the voltage +Vc at a time when the main selection operation is performed for the odd rows and sets the voltage of the common signal to the voltage Vc at a time when the main selection operation for the even rows is performed. Thus, the voltage of the common signal becomes the electric potential Cnt of zero voltage for the period Ha of any frame.

In particular, according to the second embodiment, in the period Hb of one frame, the scanning line driving circuit 140 basically selects the scanning lines 112 in order of the 1st, 2nd, 3rd, 4th, . . . , 319th, 320th rows, counted from the top, sets the scanning signals for the selected scanning lines to level H, and sets the scanning signals for other scanning lines to level L, which is the same as in the first embodiment. However, as shown in FIG. 10, as an exception, when the main selection operation is performed for the scanning line 112 of the 1st row that is the leading odd row, simultaneously the scanning lines 112 of other odd rows 3rd, 5th, 7th, . . . , 319th rows are additionally selected, unlike in the first embodiment. In addition, when the main selection operation is performed for the scanning line 112 of the 2nd row that is the leading even row, simultaneously the scanning lines 112 of other even rows 4th, 6th, 8th, . . . , 320th rows are additionally selected, unlike in the first embodiment.

Next, the operation of the electro-optical device according to the second embodiment will be described. At the start of the period Hb of the n-th frame, the scanning signals Y1, Y3, Y5, . . . , Y319 of the odd rows become the level H, and positive polarity data signals X1 to X240 corresponding to gray scales of the 1st row and 1st column to the 1st row and 240th column are output.

However, when the main selection operation is performed for the odd rows in the period Hb of the n-th frame, the voltage of the common electrode 108 is a voltage −Vc, and the data signal Xj of the j-th column is a voltage +Vseg. Accordingly, the pixel capacitor 120 of the 1st row and j-th row is charged to a voltage (Vseg+Vc) acquired from subtracting the voltage −Vc of the common electrode 108 from the voltage +Vseg corresponding to the gray scale, that is, a sum of the absolute values of the voltage of common electrode and the voltage corresponding to the gray scale. Here, although a description for the 1st row and j-th column is made, all the pixels of the 1st row are charged to voltages acquired from subtracting the voltage −Vc from the positive polarity voltages corresponding to the gray scales in the period Hb of the n-th frame. Accordingly, the black latent image display is implemented in the pixels 110 of the 1st row.

In addition, odd rows of the 3rd, 5th, 7th, 319th rows other than the 1st row are selected, and accordingly, the pixel capacitors 120 of the above-described odd rows are charged to voltages acquired from subtracting the voltage −Vc from the positive polarity voltages corresponding to the gray scales of pixels that are located in corresponding columns of the 1st row. Accordingly, the black latent image display is performed for other odd rows.

Subsequently, in the period Hb of the n-th frame, the scanning signals Y2, Y4, Y6, . . . , Y320 of even rows become the level H, and the data signals X1 to X240 having the negative polarity voltages corresponding to the gray scales of the 2nd row and 1st column to the 2nd row and 240th column are output. However, when the scanning lines of the even rows are selected in the period Hb of the n-th frame, the voltage of the common electrode 108 is a voltage +Vc, and the data signal Xj of the j-th column becomes a voltage −Vseg. Accordingly, the pixel capacitor 120 of the 2nd row and j-th column is charged to a voltage −(Vseg+Vc) acquired from subtracting the voltage +Vc from the voltage −Vseg corresponding to the gray scale, that is, a voltage of a sum of the absolute values of the voltage −Vseg and the voltage +Vc.

Here, although a description for the 2nd row and j-th column is made, the same black latent image display is performed for all the pixels of the 2nd row. In addition, since even rows of the 4th, 6th, 8th, . . . , 320th rows other than the 2nd row are additionally selected, the same black latent image display is performed for the pixels of the above-described even rows.

Thereafter, in the period Hb of the n-th frame, the scanning signals Y3, Y4, . . . , Y319, Y320 become the level H one after another. Accordingly, the pixel capacitors 120 of the odd rows are charged to voltages acquired from subtracting the voltage −Vc from the positive polarity voltages corresponding to the gray scales, and the pixel capacitors 120 of the even rows are charged to voltages acquired from subtracting the voltage +Vc from the negative polarity voltages corresponding to the gray scales, and thereby the black latent image display is maintained in the above-described pixel capacitors 120.

In addition, in the period Ha of the n-th frame, the common signal Vcom supplied to the common electrode 108 becomes the zero voltage, and the voltage of the capacitor signal Vhld1 supplied to the capacitor lines 132 of the odd rows decreases from the voltage +Vh to the zero voltage by a voltage ΔVh, and the capacitor signal Vhld2 supplied to the capacitor lines 132 of the even rows increases from the voltage −Vh to the zero voltage by a voltage ΔVh.

Accordingly, the voltages charged in the pixel capacitors 120 of the odd rows and the even rows in the period Hb decrease by a voltage Chld(ΔVc+ΔVh)/(Cpix+Chld) as the absolute value due to redistribution of charges in the period Ha. Therefore, the pixel capacitor has transmittance corresponding to the gray scale, and whereby a desired image can be displayed (real image display).

In the next (n+1)-th frame, a same operation is performed except that the writing polarities for the odd rows and the even rows are inverted.

Accordingly, the pixel capacitors 120 of the 1st row among the odd rows are charged to a voltage acquired from subtracting the voltage +Vc from the negative polarity voltages corresponding to the gray scales of the pixels. In addition, the pixel capacitors 120 of the 3rd, 5th, 7th, 319th rows other than the 1st row are charged to same voltages as the voltages of the pixel capacitors of the 1st row located in corresponding columns at a time when the main selection operation is performed for the 1st row. Thereafter, when the pixel capacitors 120 of the 3rd, 5th, 7th, . . . , 319th rows are reselected, the pixel capacitors 120 are charged to voltages acquired from subtracting a voltage +Vc from the negative polarity voltages corresponding to the gray scales of the pixels again.

In addition, the pixel capacitors 120 of the 2nd row among the even rows are charged to a voltage acquired from subtracting the voltage Vc from the positive polarity voltages corresponding to the gray scales of the pixels. In addition, the pixel capacitors 120 of the 4th, 6th, 8th, . . . , 320th rows other than the 2nd row are charged to same voltages as the voltages of the pixel capacitors of the 2nd row located in corresponding columns at a time when the main selection operation is performed for the 2nd row. Thereafter, when the pixel capacitors 120 of the 4th, 6th, 8th, . . . , 320th rows are reselected, the pixel capacitors 120 are charged to voltages acquired from subtracting the voltage −Vc from positive polarity voltages corresponding to the gray scales of the pixels again.

In addition, in the period Ha of the (n+1)-th frame, the common signal Vcom supplied to the common electrode 108 becomes the zero voltage, and the voltages of the capacitor lines 132 of the odd rows increase by a voltage ΔVh, and the voltages of the capacitor lines 132 of the even rows increase by a voltage ΔVh. Accordingly, the voltages charged in the pixel capacitors 120 of the odd rows and the even rows for the period Hb decrease by a voltage Chld(ΔVc+ΔVh)/(Cpix+Chld) as an absolute value due to redistribution of charges for the period Ha, and thereby transmittance corresponding to the gray scales can be acquired.

Here, a notable point in the second embodiment is that the voltage of the common electrode 108 is not constant for the period Hb and is switched between voltages −Vc and +Vc each time the scanning line is selected. In other words, the voltage of the common electrode increases and decreases by 2ΔVc repeatedly. Thus, according to the second embodiment, in the period Hb, the absolute value of the voltage charged in the pixel capacitor 120 is alternately switched between |Vseg+Vc| and (Vseg+Vc)−Chld·(2ΔVc)/(Cpix+Chld)| for the j-th column. Accordingly, there is a case where ideal black display is not implemented.

Thus, in the second embodiment, a configuration in which a back light not shown in the figure is provided and the back light is turned off only for the period Hb for implementing the black display even for a case where the absolute value of the voltage charged in the pixel electrode 120 becomes |(Vseg+Vc)−Chld·(2ΔVc)/(Cpix+Chld)| is used.

In addition, when such a method using the back light together is considered, for example, in a general configuration as shown in FIG. 18, the period for black display can be lengthened by turning on the back light for a period p and turning off the back light for the other period. However, under such a configuration, since the period p is short, luminance of the entire screen is insufficient so as to darken the screen. In order to prevent darkening of the screen, a method in which the back light is turned on for a period q that includes the period p may be considered. However, in such a case, both a row for which the writing operation is completed and transmittance corresponding to the gray scale is implemented and a row for which the writing operation is not completed and transmittance corresponding to the gray scale is not implemented are visually recognized, and thereby uneven display is generated.

On the other hand, according to the second embodiment, the writing operations for all the rows are completed in the period Ha. Thus, according to the second embodiment, there is an advantage that uneven display is not generated even for a case where the back light is used together.

### Applied and Modified Example of Second Embodiment

In the above-described embodiment, the common electrode 108 is commonly used for the odd rows and the even rows. However, as shown in FIG. 11, similarly to the capacitor lines 132, a configuration in which the common electrodes 108 are divided into a group of odd rows and a group of even rows and the common electrode driving circuit 170 supplies a common signal Vcom1 to the common electrodes 108 of the odd rows and supplies a common signal Vcom2 to the common electrodes 108 of the even rows may be used.

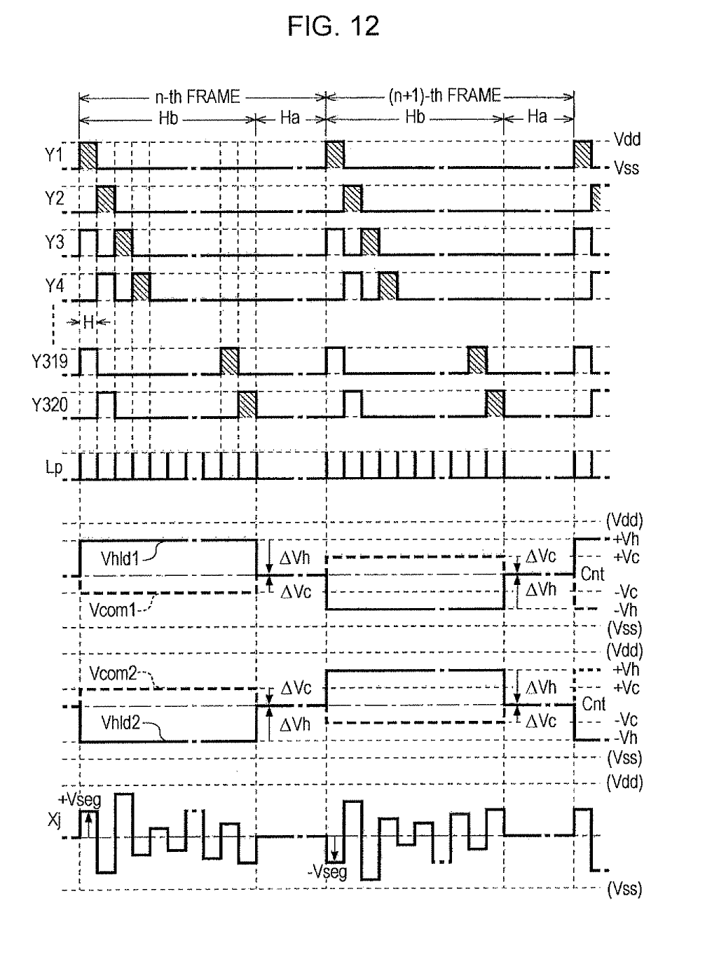

Here, the common signals Vcom1 and Vcom2 may have voltage waveforms as denoted by broken lines shown in FIG. 12. In other words, the common signal Vcom1 for the odd rows is set to have a voltage −Vc in the period Hb of the n-th frame and is set to have a voltage +Vc in the period Hb of the (n+1)-th frame, and thus the common signal Vcom1 of the odd rows are set to have the electric potential Cnt of the zero voltage in the period Ha of each frame. In addition, the common signal Vcom2 for the even rows is set to have a voltage +Vc in the period Hb of the n-th frame and is set to have a voltage −Vc in the period Hb of the (n+1)-th frame, and thus the common signal Vcom2 of the even rows are set to have the electric potential Cnt of the zero voltage in the period Ha of each frame.

As described above, when the common electrodes 108 are divided into the group of the odd rows and the group of the even rows, the absolute value of the voltage charged in the pixel capacitor 120 becomes |Vseg+Vc| in the period Ha, and thus the black latent image can be implemented without turning the back light off. In addition, since the voltage of the common electrode is not switched for the period Hb, power consumption due to redistribution of charges or parasitic capacitance can be suppressed, and accordingly, the configuration of the common electrodes has an advantage for low power consumption.

In addition, in the second embodiment or the applied and modified example of the second embodiment, as in the applied and modified example of the first embodiment, the voltage amplitude W of the data signals X1 to X240 can decrease by lowering the reference electric potential of the positive polarity writing and the voltage −Vc and elevating the reference electric potential for the negative polarity writing and the voltage +Vc.

### Third Embodiment

Next, a third embodiment of the invention will be described. In an electro-optical device according to the third embodiment, the writing polarity is inverted by using the scanning line inversion method as in the second embodiment, and power consumption lower than that of the second embodiment is implemented.

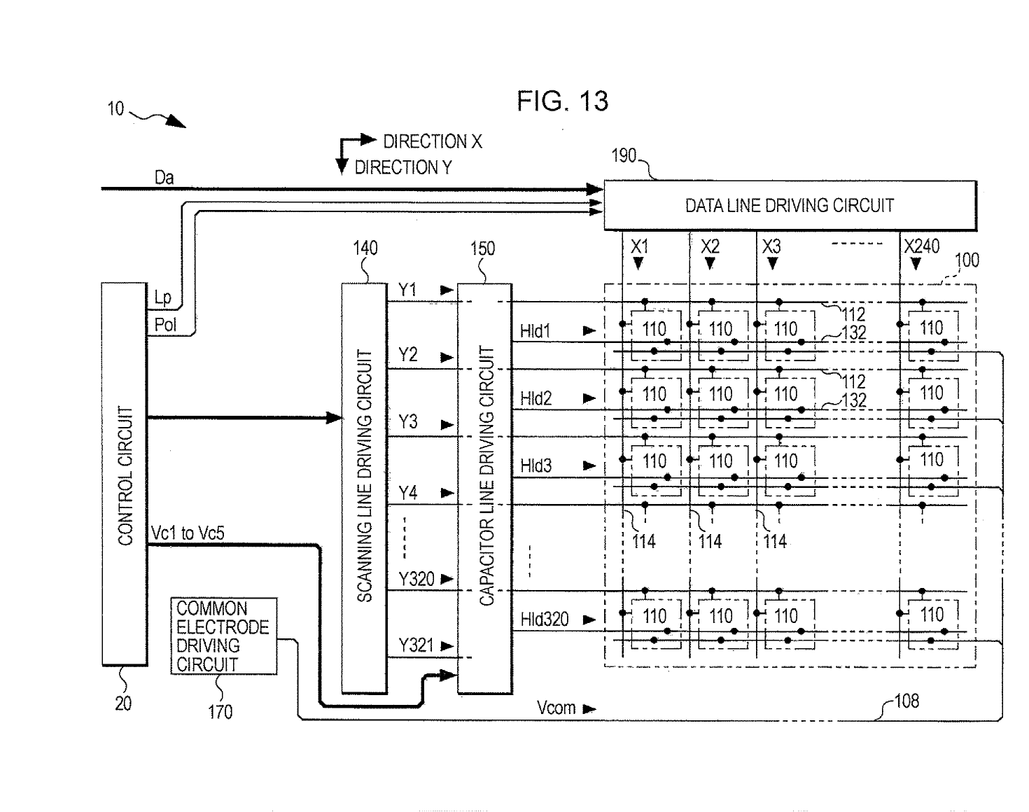

FIG. 13 is a block diagram showing the configuration of the electro-optical device according to the third embodiment. As shown in the figure, according to the third embodiment, while the common electrode 108 is common to all the pixels 110, the capacitor lines 132 are disposed for each of the 1st to 320th rows. Here, to the capacitor lines 132 of the 1st to 320th rows, capacitor signals Hld1 to Hld320 are supplied by the capacitor line driving circuit 150.

In addition, the capacitor line driving circuit 150 may be configured to be formed together with the scanning line driving circuit 140 and the data line driving circuit 190 in the vicinity of the display area 100 on the component substrate. Alternatively, the capacitor line driving circuit 150 may be configured by mounting a separate IC chip on the component substrate.

According to the third embodiment, in the scanning line driving circuit 140, a dummy scanning line of the 321st row is disposed, and the scanning line driving circuit 140 line outputs a scanning signal Y321 in addition to the scanning signals Y1 to Y320. Here, the operation of the scanning line driving circuit 140 performs the original operation only. However, since the dummy scanning line is disposed in the 321st row, the scanning line driving circuit 140 performs the main selection operation for the scanning lines 112 in order of 1st, 2nd, 3rd, 4th, . . . , 319th, 320th, 321st in the period Hb of one frame. Then, the scanning signal for the selected scanning lines is set to the level H, and scanning signals for the other scanning lines are set to level L.

In the third embodiment, the operation for selecting each row is performed only once in one frame. In the operation for selecting one of the 1st to 320th rows, voltages corresponding to the gray scales are applied to the pixel electrodes, and thus a selection operation and a main selection operation mean the same in that case. However, since the 321st row is a dummy, there is no main selection operation for the 321st row.

Here, in the third embodiment, as in the second embodiment, it is assumed that the positive polarity writing is designated for the odd rows and the negative polarity writing is designated for the even rows, in the n-th frame. In addition, it is assumed that the negative polarity writing is designated for the odd rows, and the positive polarity writing is designated for the even rows, in the (n+1)-th frame.

For the convenience of description, it is assumed that i is an odd number and (i+1) is an even number following right after i. When a capacitor signal supplied to the capacitor line 132 of the i-th row is denoted by Hldi and a capacitor signal supplied to the capacitor line 132 of the (i+1)-th row is denoted by Hld(i+1), the capacitor line driving circuit 150 outputs the capacitor signals Hldi and Hld(i+1) having the voltage values as below.

The capacitor line driving circuit 150 sets the capacitor signal Hldi supplied to the capacitor line 132 of the i-th row that is an odd row (to be a voltage −Vh1 from the start of the period Hb of the n-th frame to selection of the scanning line of the i-th row, sets to be a voltage +Vh1 at a time when the selection of the scanning line of the i-th row is completed, and sets to be a voltage +Vh2 for the period Ha. Next, the capacitor line driving circuit 150 sets the capacitor signal Hldi to be a voltage +Vh1 again from the start of the period Hb of the (n+1)-th frame to selection of the scanning line of the i-th row, sets to be a voltage −Vh1 at a time when the selection of the scanning line of the i-th row is completed, and sets to be a voltage −Vh2 for the period Ha.

On the other hand, the capacitor line driving circuit 150 sets the capacitor signal Hld(i+1) supplied to the capacitor line 132 of the (i+1)-th row that is an even row to be a voltage +Vh1 from the start of the period Hb of the n-th frame to selection of the scanning line of the (i+1)-th row, sets to be a voltage −Vh1 at a time when the selection of the scanning line of the (i+1)-th row is completed, and sets to be a voltage Vh2 for the period Ha. Next, the capacitor line driving circuit 150 sets the capacitor signal Hld(i+1) to be a voltage −Vh1 again from the start of the period Hb of the (n+1)-th frame to selection of the scanning line of the (i+1)-th row, sets to be a voltage +Vh1 at a time when the selection of the scanning line of the (i+1)-th row is completed, and sets to be a voltage +Vh2 for the period Ha.

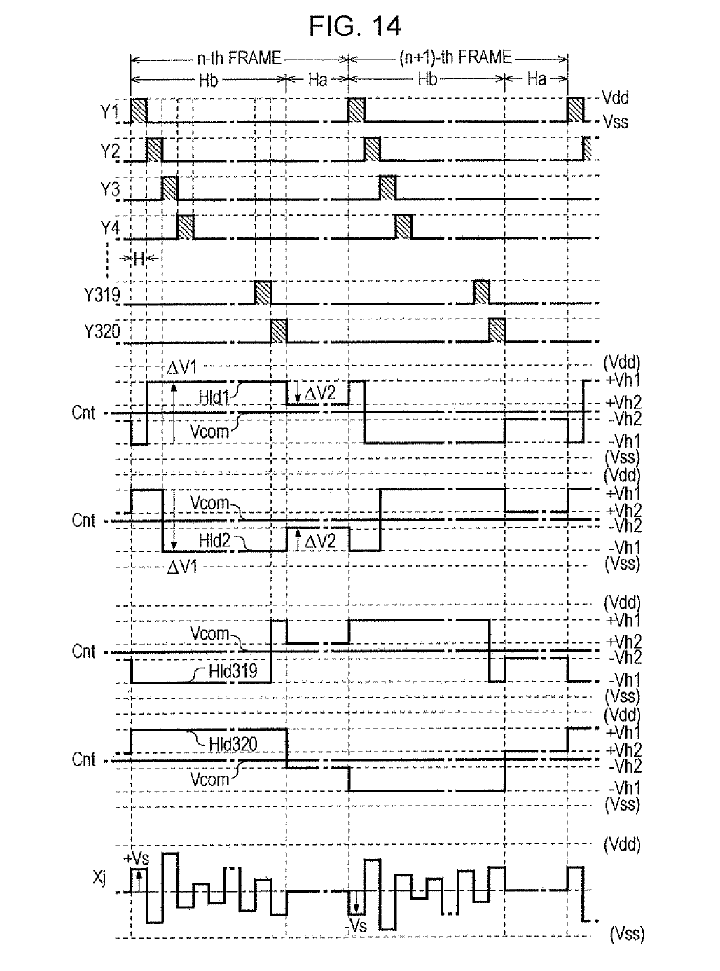

In addition, among the capacitor lines Hld1 to Hld320, capacitor signals Hld1, Hld2, Hld319, and Hld320 that are supplied to the capacitor lines of the 1st, 2nd, 319th, and 320th rows are as shown in FIG. 14.

The common electrode driving circuit 170 sets the common signal Vcom to have the electric potential Cnt of the zero voltage as a constant.

In the period Hb of the n-th frame, the scanning signals Y1, Y2, Y3, Y4, . . . , Y319, Y320 become the level H one after another.

Here, when the i-th row that is an odd row is selected and the scanning signal Yi becomes the level H, it is assumed that the data signal Xj of the j-th column has a voltage +Vs having the positive polarity. When the i-th row is selected, the capacitor line 132 of the i-th row has a voltage −Vh1. Then, when the selection is completed, the voltage value of the capacitor line of the i-th row changes to a voltage +Vh1. When the voltage difference for this change is ΔV1 (=2ΔVh1), the pixel electrode 118 of the i-th row and j-th column has a voltage +(Vs+KΔV1). Here, K Chld/(Cpix+Chld).

On the other hand, when the (i+1)-th row that is an even row is selected and the scanning signal Y(i+1) becomes the level H, it is assumed that the data signal Xj of the j-th column has a voltage −Vs having the negative polarity. When the (i+1)-th row is selected, the capacitor line 132 of the (i+1-th row has a voltage +Vh1. Then, when the selection is completed, the voltage value of the capacitor line of the (i+1)-th row changes to a voltage −Vh1. Accordingly, the pixel electrode 118 of the (i+1)-th row and j-th column has a voltage −(Vs+KΔV1).

When all the scanning lines of the 1st to 320th rows are selected in the period Hb of the n-th frame, the period Ha is started, and the voltage of the capacitor line 132 of the i-th row that is an odd row is lowered from the voltage +Vh1 to the voltage +Vh2. When the voltage difference for the change is denoted by ΔV2 (=|Vh1−Vh2|), the pixel electrode 118 of the i-th row and j-th column has a voltage (Vs+K(ΔV1−ΔV2)).

On the other hand, in the period Ha of the n-th frame, the voltage of the capacitor line 132 of the (i+1)-th row that is an even row is elevated from the voltage −Vh1 to the voltage −Vh2, and accordingly, the pixel electrode 118 of the (i+1)-th row and j-th column has a voltage (Vs+K(ΔV1−ΔV2)).

In addition, in the next (n+1)-th frame, a relationship between the even rows and odd rows in the n-th frame is reversed.

In the third embodiment, the voltages ±Vh1 and ±Vh2 are set such that, in the period Ha, the voltage (Vs+K(ΔV1−ΔV2)) becomes a positive polarity voltage corresponding to the gray scale and the voltage −((Vs+K(ΔV1−ΔV2)) becomes a negative polarity voltage corresponding to the gray scale.

In addition, in the first and second embodiments, in the period Hb, the absolute value of the voltage +Vseg or −Vseg of the data signal Xj supplied, for example, in a case where i-th row is selected is the same as the voltage maintained in the pixel capacitor of the i-th row and j-th column in the period Ha thereafter. Although, in the third embodiment, the absolute value of the voltage +Vs or −Vs of the data signal Xj supplied in a case where the i-th row is selected does not coincide with the voltage that is maintained in the pixel capacitor of the i-th row and j-th column in the period Ha thereafter, the absolute value can be considered as a voltage value corresponding to the gray scale of the pixel of the i-th row and j-th column.

In addition, in the period Hb, the pixel electrode 118 after completion of selection of the scanning line is a voltage (Vs+KΔV1) in a case where the positive polarity writing is designated and is a voltage −(Vs+KΔV1) in a case where the negative polarity writing is designated. Accordingly, the voltage KΔV1 is set such that the black latent image display is implemented in the pixel 110 at that moment.

Accordingly, also in the third embodiment, as in the second embodiment, the scanning line inversion is performed, and then, the black latent image is implemented in the pixel 110 in the period Hb, and real image display in which the transmittance is determined in accordance with the gray scale is implemented in the pixel in the period Ha.

In addition, according to the third embodiment, since the common electrode has a constant electric potential Cnt, the number of times of voltage switching in one frame is zero for the common electrode 108. In addition, since the voltage of each capacitor line is switched at the start of the period Hb, after completion of selection of the scanning line, and at the start of the period Ha, the number of times of voltage switching is three for the capacitor lines 132 of the 1st to 319th rows. In addition, since the completion of selection of the scanning line and the start of the period Ha are at the same time, the number of times of voltage switching for the capacitor line 132 of the 320th row is two that is smaller than that for the capacitor lines of other rows by one. As a result, according to the third embodiment, it is possible to suppress unnecessary power consumption due to parasitic capacitance that is generated in accompaniment with voltage switching, compared to the second embodiment.

In addition, according to the third embodiment, the common electrode 108 is commonly used for all the pixels 110, and is not needed to be divided into groups of odd rows and even rows, unlike in the applied and modified example (see FIG. 11) of the second embodiment. Accordingly, the patterning process is omitted, and thus, the manufacturing process can be simplified.

### Applied and Modified Example of Third Embodiment

In descriptions above, only the voltage waveforms of the capacitor signals Hld1 to Hld320 that are output from the capacitor line driving circuit 150 are described. Thus, an example of a detailed configuration of the capacitor line driving circuit 150 will now be described. This example is appropriate to a configuration in which the capacitor line driving circuit 150 is formed on the component substrate.

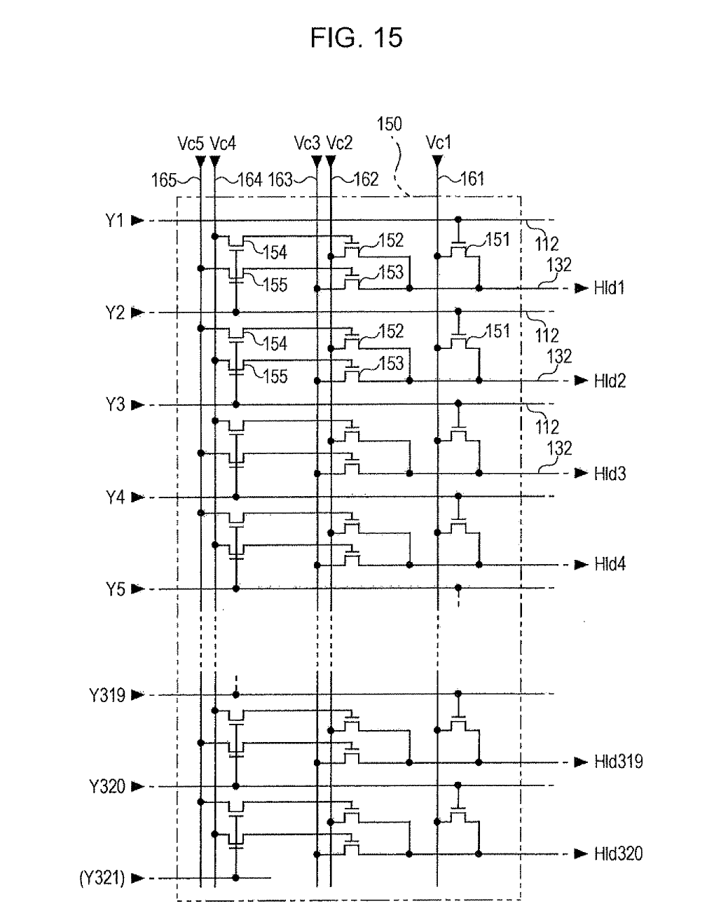

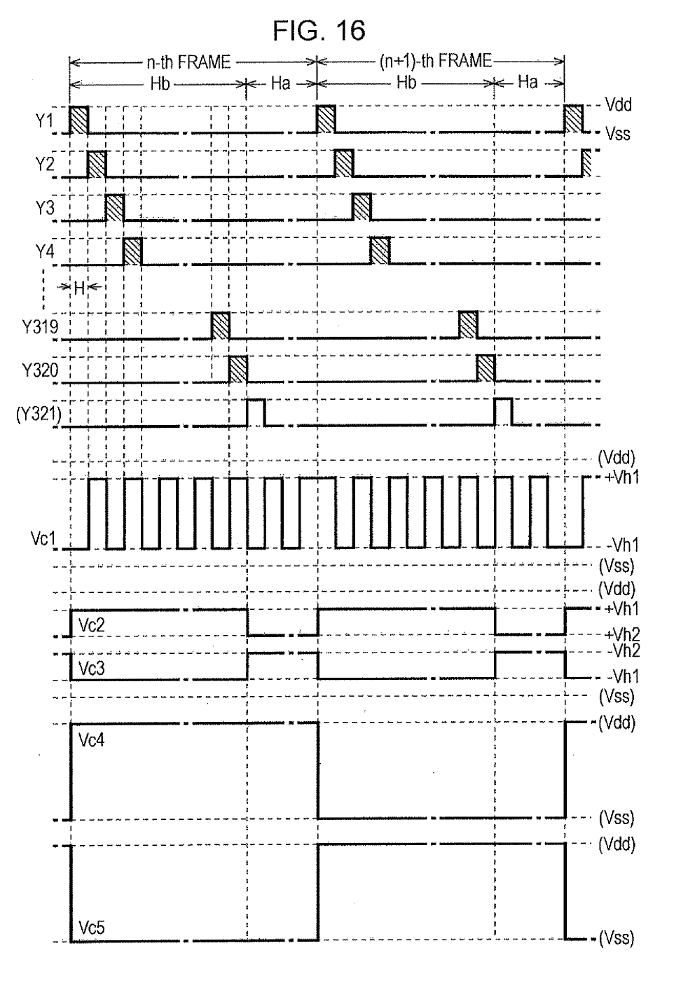

FIG. 15 is a diagram showing the configuration of the capacitor line driving circuit 150 according to the third embodiment. FIG. 16 is a diagram showing the voltage waveforms of signals Vc1 to Vc5 that are supplied to the capacitor line driving circuit 150 from the control circuit 20.

As shown in FIG. 15, the capacitor line driving circuit 150 has a group of TFTs 151 to 155 in correspondence with the capacitor lines 132 of the 1st to 320th rows.

Here, the TFT 151 of the i-th row that is an odd row has a gate electrode connected to the scanning line 112 of the i-th row and a source electrode connected to a signal line 161 through which a signal Vc1 is supplied. In addition, the TFT 152 of the i-th row that is an odd row has a gate electrode connected to the drain electrode of the TFT 154 of the i-th row and a source electrode connected to a signal line 162 through which a signal Vc2 is supplied. The TFT 153 of the i-th row has a gate electrode connected to the drain electrode of the TFT 155 of the i-th row and a source electrode connected to a signal line 163 through which a signal Vc3 is supplied. In addition, the drain electrodes of the TFTs 152 and 153 of the i-th row are connected to the capacitor line 132 of the i-th row together with the drain electrode of the TFT 151.

In addition, the TFT 154 of the i-th row has a gate electrode connected to the scanning line 112 of the (i+1)-th row and a source electrode connected to a signal line 164 through which a signal Vc4 is supplied. The TFT 155 of the i-th row has a gate electrode connected to the scanning line 112 of the (i+1)-th row and a source electrode connected to a signal line 165 through which a signal Vc5 is supplied.

In addition, connection spots of the source electrodes of the TFTs 154 and 155 are interchanged between the (i+1)-th row that is an even row and the i-th row that is an odd row. In addition, the source electrode of the TFT 154 is connected to the signal line 165, and the source electrode of the TFT 155 is connected to the signal line 164. The configuration of other parts of the (i+1)-th row is the same as that of the i-th row.

Next, in the n-th frame, the signal Vc1 has a voltage −Vh1 in a case where an odd row is selected and has a voltage +Vh1 in a case where an even row is selected. In addition, in the (n+1)-th frame, the signal Vc1 has a voltage +Vh1 in a case where an odd row is selected and has a voltage −Vh1 in a case where an even row is selected.

The signal Vc2 has a voltage +Vh1 in the period Hb of each frame and has a voltage +Vh2 in the period Ha. In addition, the signal Vc3 has a voltage Vh1 in the period Hb of each frame and has a voltage −Vh2 in the period Ha.

The signal Vc4 has the ON voltage in the n-th frame and has the OFF voltage in the (n+1)-th frame. On the other hand, the signal Vc5 has the OFF voltage in the n-th frame and has the ON voltage in the (n+1)-th frame. Here, the ON voltage is a selection voltage for turning on the TFTs 152 and 153 in a case where the ON voltage is applied to the gate electrodes of the TFTs 152 and 153. In addition, the OFF voltage is a non-selection voltage for turning off the TFTs 152 and 153 in a case where the OFF voltage is applied to the gate electrodes of the TFTs 152 and 153.

Under such a configuration, when the i-th row, that is an odd row is selected in the n-th frame, the TFT 151 of the i-th row is turned on, and accordingly, the capacitor line 132 of the −i-th row has the voltage −Vh1 that is the voltage value of the signal Vc1.

Next, when the selection of the i-th row is completed and the (i+1)-th row is selected, the TFTs 154 and 155 of the i-th row are turned on. Accordingly, to the gate electrodes of the TFTs 152 and 153 of the i-th row, the ON voltage and the OFF voltage are applied, and thus the TFTs 152 and 153 are turned on and turned off. On the other hand, the TFT 151 of the i-th row is turned off. Accordingly, the capacitor line 132 of the i-th row has the voltage +Vh1 that is the voltage value of the signal line Vc2.

When the selection of the (i+1)-th row is completed, the TFTs 154 and 155 of the i-th row are turned off. However, to the gate electrodes of the TFTs 152 and 153 of the i-th row, the ON voltage and the OFF voltage of the prior states are maintained due to parasitic capacitance, and accordingly, the On state and the OFF state of the TFTS 152 and 153 are continued. Accordingly, the capacitor line 132 of the i-th row has a voltage +Vh2 that is the voltage value of the signal Vc2 in the period Ha. In addition, from the start of the period Hb of the (n+1)-th frame to the completion of selection of the i-th row, the capacitor line 132 of the i-th row has a voltage +Vh1 that is the voltage value of the signal Vc2.

In addition, in the selection period of the i-th row of the (n+1-th frame, both the TFTs 151 and 152 are turned on. However, in this selection period, both the signals Vc1 and Vc2 have a voltage +Vh1, and thus, there is no problem.

On the other hand, when the (i+1)th row that is an even row is selected in the n-th frame, the TFT 151 of the (i+1)-th row is turned on, and accordingly, the capacitor line 132 of the (i+1)-th row has a voltage +Vh1 that is the voltage value of the signal Vc1. Next, when the selection of the (i+1)-th row is completed and the (i+2)-th row is selected, the TFTs 154 and 155 of the (i+1)-th row are turned on. Accordingly, to the gate electrodes of the TFTs 152 and 153 of the (i+1)-th row, the OFF voltage and the ON voltage are applied, and thus the TFTs 152 and 153 are turned off and turned on. On the other hand, the TFT 151 of the (i+1)-th row is turned off. Accordingly, the capacitor line 132 of the (i+1)th row has a voltage −Vh1 that is the voltage value of the signal line Vc3. When the selection of the (i+2)-th row is completed, the TFTs 154 and 155 of the (i+1)-th row are turned off. However, to the gate electrodes of the TFTs 152 and 153 of the (i+1)-th row, the OFF voltage and the ON voltage of the prior states are maintained due to parasitic capacitance, and accordingly, the On state and the OFF state of the TFTs 152 and 153 are continued. Accordingly, the capacitor line 132 of the (i+1)-th row has a voltage −Vh2 that is the voltage value of the signal Vc3 in the period Ha. In addition, from the start of the period Hb of the (n+1)-th frame to the completion of selection of the (i+1)-th row, the capacitor line 132 of the (i+1)-th row has a voltage −Vh1 that is the voltage value of the signal Vc3.

In addition, in the selection period of the (i+1)-th row of the (n+1)-th frame, both the TFTs 151 and 153 are turned on. However, in this selection period, both signals Vc1 and Vc2 has the voltage −Vh1, and accordingly, there is no problem.

In addition, in the i-th row that is an odd row, the operation after the selection period of the (n+1)-th frame is the same as the operation after the selection period of the n-th frame in the (i+1)-th row that is an even row. In addition, the operation after the selection period of the (n+1)-th frame in the (i+1)-th row that is an even row is the same as the operation after the selection period of the n-th frame in the i-th row that is an odd row.

Accordingly, by supplying the signals Vc1 to Vc5 as shown in FIG. 16 to the capacitor line driving circuit 150 shown in FIG. 15 from the control circuit 20, the capacitor signals Hld1 to Hld320 of each row can be set to have the voltage waveforms as shown in FIG. 14.

In addition, in each of the above-described embodiments, as the pixel capacitor 120, a configuration in which the pixel electrode 118 and the common electrode 108 pinches the OCB liquid crystal 105 is used. However, a liquid crystal of any other type may be used as long as it has high response speed. In addition, the pixel capacitor 120 is not limited to the transmission-type, and thus the pixel capacitor may be a reflection-type or a so-called semi-transmission and semi-reflection type that combines the transmission-type and the reflection-type.

The color display may be performed by configuring one dot by using three pixels of R (red), G (green), and B (blue). In addition, for example, G may be divided into YG (yellow green) and EG (emerald green), and one dot may be configured by using the four color pixels for forming a broad color band.

### Electronic Apparatus

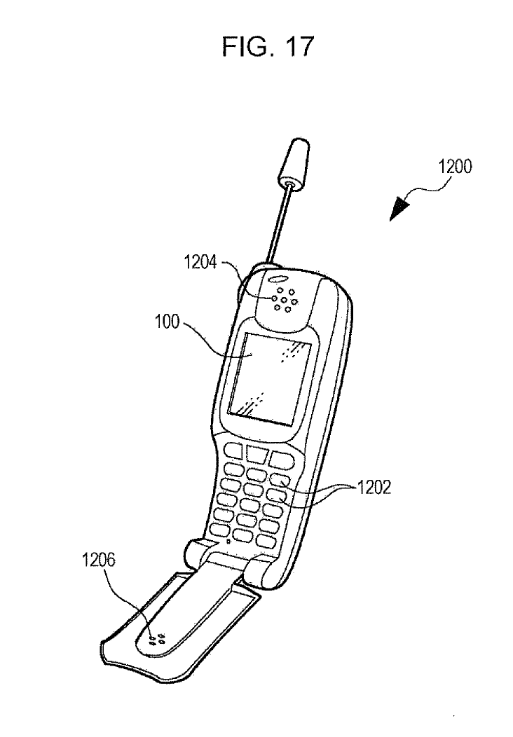

Next, an electronic apparatus having the electro-optical device 10 according to the above-described embodiments as a display device will be described. FIG. 17 is a diagram showing the configuration of a cellular phone 1200 using the electro-optical device 10 according to any one of the above-described embodiments.

As shown in the figure, the cellular phone 1200 has an ear piece 1204, a mouth piece 1206, and the above-described electro-optical device 10 in addition to a plurality of operation buttons 1202. The constituent elements of a part corresponding to the display area 100 of the electro-optical device 10 does not appear externally.

In addition, as an electronic apparatus to which the electro-optical device 10 is applied, other than the cellular phone shown in FIG. 17, there are examples including a digital still camera, a notebook PCr a liquid crystal TV set, a view finder-type (or direct-view type) video cassette recorder, a car navigation system, a pager, an electronic organizer, a calculator, a word processor, a workstation, a video phone, a POS terminal, a photo storage viewer, an apparatus having a touch panel, and the like. It is apparent that as display devices of the various electronic apparatuses, the above-described electro-optical device 10 can be applied.

The entire disclosure of Japanese Patent Application NO. 2008-49267 filed Feb. 29, 2008 is expressly incorporated by reference herein.

What is claimed is:

1. A method of driving an electro-optical device including:
a plurality of scanning lines;
a plurality of data lines;
a plurality of pixels that are disposed in correspondence with intersections of the plurality of scanning lines and the plurality of data lines;
a scanning line driving circuit that selects the plurality of scanning lines in a predetermined order in a first period of a first frame period; and
a data line driving circuit that supplies data signals having voltage values corresponding to gray scales of pixels through the plurality of data lines to the pixels corresponding to the scanning line, for which a main selection operation is performed, among the plurality of scanning lines,
wherein each of the plurality of pixels includes:
a pixel switching element that has one end connected to the data line and is in the ON state between the one end and the other end at a time when the scanning line is selected;
a pixel capacitor that has one end connected to the other end of the pixel switching element and the other end connected to a common electrode; and
a storage capacitor that has one end connected to the other end of the pixel switching element and the other end connected to a capacitor line,
the method comprising:
maintaining a voltage for black display in the pixel capacitors corresponding to one of the plurality of scanning lines from when the first period is started to when the main selection operation is performed for the one scanning line;
writing voltages acquired from adding a predetermined voltage value to voltages of the data signals into the pixel capacitors at a time when the main selection operation is performed for the one scanning line in the first period; and
changing a voltage of at least one between the common electrode and the capacitor line in a second period that is a period after the first period of the first frame period.

2. The method according to claim 1,
wherein other scanning lines are additionally selected when the main selection operation is performed for a first scanning line in the first period, and
wherein the voltage value for the black display is maintained in the pixel capacitors corresponding to the other scanning lines.

3. The method according to claim 1,
wherein all the plurality of scanning lines are selected at the start of the first period, and then, the main selection operation is performed for the plurality of scanning lines in a predetermined order, and
wherein the voltage value for the black display is maintained for all the pixel capacitors at a time when all the plurality of scanning lines are selected.

4. The method according to claim 1,
wherein the capacitor lines are divided into a group of the capacitor lines corresponding to the scanning lines of odd rows and a group of the capacitor lines corresponding to the scanning lines of even rows,
wherein, when the main selection operation is performed for the scanning line of an odd row for the first time in the first period, the scanning lines of the other odd rows are additionally selected, and the voltage for the black display is maintained in the pixel capacitors corresponding to the scanning lines of the other odd rows,
wherein, when the main selection operation is performed for the scanning line of an even row for the first time in the first period, the scanning lines of the other even rows are additionally selected, and the voltage for the black display is maintained in the pixel capacitors corresponding to the scanning lines of the other even rows,
wherein, in the first period, when the main selection operation is performed for the scanning line of an odd row, the common electrode is set to have one between a low-level voltage or a high-level voltage, and when the main selection operation is performed for the scanning line of an even row, the common electrode is set to have the other between the low-level voltage and the high-level voltage, and
wherein, when the main selection operation is performed for one of the plurality of the scanning lines, the data signal is set to have a voltage higher than the low-level voltage in a case where the common electrode is set to have the low-level voltage, and the data signal is set to have a voltage lower than the high-level voltage in a case where the common electrode is set to have the high-level voltage.

5. The method according to claim 1,
wherein the capacitor lines and the common electrodes are divided into a group corresponding to the scanning lines of odd rows and a group corresponding to the scanning lines of even rows, respectively,
wherein, when the main selection operation is performed for the scanning line of an odd row for the first time in the first period, the scanning lines of the other odd rows are additionally selected, and the voltage for the black display is maintained in the pixel capacitors corresponding to the scanning lines of the other odd rows,
wherein, when the main selection operation is performed for the scanning line of an even row for the first time in the first period, the scanning lines of the other even rows are additionally selected, and the voltage for the black display is maintained in the pixel capacitors corresponding to the scanning lines of the other even rows,
wherein, in the first period, the common electrodes corresponding to the odd rows are set to have one between a low-level voltage and a high-level voltage, and the common electrodes corresponding to the even rows are set to have the other between the low-level voltage and the high-level voltage,
wherein, the data signal at a time when the main selection operation is performed for the scanning line of the odd row is set to have a voltage higher than the low-level voltage in a case where the common electrodes of the odd row are set to have the low-level voltage, and the data signal at a time when the main selection operation is performed for the scanning line of the odd row is set to have a voltage lower than the high-level voltage in a case where the common electrodes of the odd row are set to have the high-level voltage, and
wherein, the data signal at a time when the main selection operation is performed for the scanning line of the even row is set to have a voltage higher than the low-level voltage in a case where the common electrodes of the even row are set to have the low-level voltage, and the data signal at a time when the main selection operation is performed for the scanning line of the even row is set to have a voltage lower than the high-level voltage in a case where the common electrodes of the even row are set to have the high-level voltage.

6. The method according to claim 1,
wherein the capacitor lines are associated with the plurality of scanning lines,
wherein the common electrode is maintained to have a predetermined reference electric potential,
wherein the voltage of the data signal is set to have one between a high-level voltage and a low-level voltage relative to the reference electric potential in a case where the main selection operation is performed for the scanning line of an odd row and is set to have the other between the high-level voltage and the low-level voltage in a case where the main selection operation is performed for the scanning line of an even row,
wherein, when the main selection operation is performed for the scanning line of the odd row, in a case where the voltage of the data signal is set to have the high-level voltage, the capacitor line of the odd row for which the main selection operation is performed is set to have the low-level voltage and is switched to have the high-level voltage at a time when the main selection operation for the scanning line of the odd row is completed,
wherein, when the main selection operation is performed for the scanning line of the odd row, in a case where the voltage of the data signal is set to have the low-level voltage, the capacitor line of the odd row for which the main selection operation is performed is set to have the high-level voltage and is switched to have the low-level voltage at a time when the main selection operation for the scanning line of the odd row is completed,
wherein, when the main selection operation is performed for the scanning line of the even row, in a case where the voltage of the data signal is set to have the low-level voltage, the capacitor line of the even row for which the main selection operation is performed is set to have the high-level voltage and is switched to have the low-level voltage at a time when the main selection operation for the scanning line of the even row is completed, and
wherein, when the main selection operation is performed for the scanning line of the even row, in a case where the voltage of the data signal is set to have the high-level voltage, the capacitor line of the even row for which the main selection operation is performed is set to have the low-level voltage and is switched to have the high-level voltage at a time when the main selection operation for the scanning line of the even row is completed.

7. An electro-optical device comprising:
a plurality of scanning lines;
a plurality of data lines; and
pixels disposed in correspondence with intersections of the plurality of scanning lines and the plurality of data lines, each including:
a pixel switching element that has one end connected to the data line and is in the ON state between the one end and the other end at a time when the scanning line is selected;
a pixel capacitor that has one end connected to the other end of the pixel switching element and the other end connected to a common electrode; and
a storage capacitor that has one end connected to the other end of the pixel switching element and the other end connected to a capacitor line,
a scanning line driving circuit that selects the plurality of scanning lines in a predetermined order in a first period of a first frame period;
a data line driving circuit that supplies data signals having voltage values corresponding to gray scales of pixels through the plurality of data lines to the pixels corresponding to the scanning line, for which a main selection operation is performed, among the plurality of scanning lines; and
a control circuit that maintains a voltage for black display in the pixel capacitors corresponding to one of the plurality of scanning lines from when the first period is started to when the main selection operation is performed for the one scanning line, writes voltages acquired from adding a predetermined voltage value to voltages of the data signals into the pixel capacitors at a time when the main selection operation is performed for the one scanning line in the first period, and changes a voltage of at least one between the common electrode and the capacitor line in a second period that is a period after the first period of the first frame period.

8. An electronic apparatus comprising the electro-optical device according to claim 7.
